(19) United States
(12) Patent Application Publication
(10) Pub. No.: US 2025/0253709 A1
(43) Pub. Date: Aug. 7, 2025

(54) WIRELESS METHOD AND SYSTEM FOR BIDIRECTIONAL TRANSFER OF POWER BETWEEN A DC POWER SOURCE AND AN ELECTRIC MOTOR-GENERATOR ROTOR

(71) Applicant: Daanaa Resolution Inc., Vancouver (CA)

(72) Inventors: Soroush Dehghani MOHAMMADABADI, Vancouver (CA); Ehsan Hadizadeh HAFSHEJANI, Vancouver (CA); Ehud DAON, Bowen Island (CA)

(21) Appl. No.: 19/044,931

(22) Filed: Feb. 4, 2025

Related U.S. Application Data
(60) Provisional application No. 63/708,900, filed on Oct. 18, 2024.
(60) Provisional application No. 63/658,629, filed on Jun. 11, 2024.
(60) Provisional application No. 63/653,577, filed on May 30, 2024.
(60) Provisional application No. 63/550,757, filed on Feb. 7, 2024.

(51) Int. Cl. H02J 50/12; H02J 50/80; H02K 13/00

(52) U.S. Cl. CPC H02J 50/12; H02J 50/80; H02K 13/003

(57) ABSTRACT

The present invention involves method and system for contactless bidirectional transfer of power between DC source and rotor coils of electric motor-generator by simultaneous bimodal capacitive and inductive power transfer of high frequency power signals from resonators stationary with respect to the motor-generator stator to resonators on the motor-generator rotor according to an adjustable transfer mode ratio at a variable resonant power signal oscillation frequency. Power from DC source is converted into high frequency power signals by high frequency continuous auto-adjusting bimodal stator transmitter-receiver modules under control of systems controller and provided to corresponding one or more high frequency stator resonators. High frequency power signals received by high frequency rotor resonators are converted in corresponding high frequency auto-adjusting bimodal rotor transmitter-receiver modules to electrical signals to provide to drive circuitry of induction coils on rotor.

### CROSS-REFERENCE TO RELATED APPLICATIONS

The present application is a nonprovisional application which claims priority under 35 U.S.C. § 119(e) of U.S. Provisional Patent Application Ser. No. 63/550,757, filed Feb. 7, 2024, and U.S. Provisional Patent Application Ser. No. 63/653,577, filed on May 30, 2024, and U.S. Provisional Patent Application Ser. No. 63/658,629, filed on Jun. 11, 2024, and

U.S. Provisional Patent Application Ser. No. 63/708,900, filed on Oct. 18, 2024; the disclosures of which are incorporated by reference herein.

### FIELD OF THE INVENTION

The invention pertains to power transmitters, receivers and systems and methods of power transfer with specific application to electrically powered automotive vehicles.

### DESCRIPTION OF RELATED ART

In inductive power transfer (IPT), power is typically transferred between coils of wire by a magnetic field. An alternating current (AC) is driven through a transmitter coil to create an oscillating magnetic field. The magnetic field passes through a receiving coil where it induces an alternating current in the receiving coil. The induced alternating current may either drive the load directly, or be rectified to direct current (DC), which is applied to drive the load. In order to achieve high efficiency, the transmitter and receiver coils must be very close together. For example, it is common for transmitter and receiver coils to be separated by only a fraction of the coil diameter (for example, within centimeters) and for the coils' axes to be closely aligned.

In some IPT systems, resonant inductive coupling is employed. Resonant inductive coupling may increase efficiency in IPT by using resonant circuits. Resonant inductive coupling may achieve higher efficiencies at greater distances than non-resonant inductive coupling. In resonant inductive coupling, power is transferred by magnetic fields between two resonant circuits, one in the transmitter and one in the receiver. The two circuits are tuned to resonate at the same resonant frequency.

In some IPT systems, magnetic fields can produce eddy-currents in nearby metals. This can cause significant temperature rise and fire hazard. Ferrite plates may be used to provide shielding and improve inductive coupling but may increase the cost of such systems.

Capacitive power transfer (CPT), makes use of electric fields for the transmission of power between two electrodes, such as metal plates. Commonly, four metal plates are used in a CPT system to form a capacitive coupler. Two plates are used as a power transmitter, and the other two plates act as a power receiver, resulting in at least two coupling capacitors to provide a power flow loop. An alternating voltage is applied by the transmitter to the transmitting plate. The oscillating electric field induces an alternating potential on the receiver plate, which causes an alternating current to flow in the load circuit. Resonance can also be used with capacitive coupling to extend the range of power transfer.

In a CPT system, eddy-current losses may be reduced and the plates used are low-cost and reduce the system cost. However, a problem with many systems is that high voltages may be imposed on the plates. These high voltages can generate strong electric fields, which result in significant field emission to the surrounding area.

There are also issues associated with the capacitive or inductive compensation networks in CPT and IPT systems. Currently, both CPT and IPT systems require minimal separation between receivers and transmitters. This typically requires large capacitors and inductors in the compensation networks on the primary and secondary sides. These large elements are difficult to produce, and their parasitic resistance can dramatically reduce the system efficiency. Additionally, these compensation elements are not directly involved in the power transfer process.

There remains a desire for wireless power transmitters and receivers with fewer components and/or reduced cost. There remains a desire for wireless power transmitters and receivers with reduced reliance on compensation networks. There remains a desire for wireless power transmitters and receivers with greater efficiency. There remains a desire for wireless power transmitters with more flexible requirements for alignment and spacing there between.

The field of power transfer as pertains to consumer products is becoming ever more important. In the automotive field, the gasoline mileage of internal combustion vehicles, carbon emissions of those vehicles, and electric vehicle range, the cost, weight, and power transfer efficiency have become items of major concern in the design of vehicles. Given that materials and components represent some 57% of automobile manufacturing costs, the concerns may be understood.

While battery technologies are steadily improving to provide higher energy density batteries, the consumer demand is simultaneously increasing for ever more ancillary user electronic devices and electrically driven systems integrated into the vehicle. This places ever greater demands on the batteries, the weight of the vehicle, the costs, and the efficiency of electrical power transfer.

At the same time, there is a need for power transfer technology efficiency to be improved to keep track with the rapidly advancing battery technology, in its turn spurred by developments in the field of electric vehicles.

In the area of electrical power transfer between stators and rotors of electric motor-generators for automotive use, there is a pressing need for avoiding the problems created by metal dust, wear, and losses from brushes used in some electric motor-generators. At the same time, the use of permanent magnets in either stators or rotors is emerging as a major concern due to problems in sourcing the rare metals involved in making high performance magnets, including neodymium, samarium and cobalt. Induction motors avoid both magnets and brushes, but they suffer from significant drawbacks. AC induction motors are not as easily controlled in terms of speed as some other types of motors, such as DC motors, and may have lower starting torque compared to some other motor types. The efficiency of AC induction motors tends to decrease at low load conditions and they can be relatively large and heavy for certain applications. Fluctuations in the power supply voltage can significantly affect AC induction motor performance and efficiency.

These requirements are not limited to the automotive field and also pertain, for example, to the field of solar energy power transfer and apply, with some modification, also to other consumer home equipment, such as computer and television displays. Power conditioning units to optimally extract power from sources with varying voltage are in extensive use today, but they generally suffer from a limited degree of control facilities. This in turn keeps the power transfer efficiency from being optimized.

The foregoing examples of the related art and limitations related thereto are intended to be illustrative and not exclusive. Other limitations of the related art will become apparent to those of skill in the art upon a reading of the specification and a study of the drawings.

### SUMMARY OF THE INVENTION

A brushless rotary electric motor-generator is provided, powerable by a DC power source, the electric motor-generator comprising: a stator comprising annularly arranged about a rotor rotation axis one of a plurality of stator magnets and a plurality of stator induction coils; a system controller disposed stationary with respect to the stator; a rotor disposed to rotate relative to the stator about the rotor rotation axis and comprising one or more rotor coils; and one or more corresponding bimodal high frequency near-field wireless power transfer links configured for transferring power across an electrical gap between the rotor and a rest of the motor-generator by simultaneous bimodal capacitive power transfer and inductive power transfer of high frequency power signals according to an adjustable transfer mode ratio at a variable resonant power signal oscillation frequency.

Each bimodal high frequency near-field wireless power transfer link may be under control of the system controller and in wired communication with the DC power source and with the one or more rotor coils via at least one coil signal controller. Each bimodal high frequency near-field wireless power transfer link may be configured for bidirectionally transferring the high frequency power signals across the electrical gap.

In a further embodiment, each bimodal high frequency near-field wireless power transfer link may comprise: disposed stationary with respect to the stator a switchable power signal modulator/rectifier in wired communication with the DC power source and with a corresponding stator resonator via a stator power signal tuning network; and disposed on the rotor a power signal conversion circuit in wired communication with a corresponding rotor resonator via a rotor power signal tuning network and with a rotor coil via a coil interface. Each switchable power signal modulator/rectifier may be configured to be switchable between a first modulating and a second rectifying mode; each power signal conversion circuit may be configured to be switchable between a first amplifying mode and a second rectifying and unfolding mode; and when a switchable power signal modulator/rectifier is switched to one of its first and its second mode, the corresponding power signal conversion circuit is switched to the other of its first and its second mode.

In the latter embodiment, each switchable power signal modulator/rectifier, when in the modulating mode, is configured for receiving from the DC power source a DC power signal and producing from the DC power signal first and second power signals having between them one of a phase difference and a frequency difference and for providing the first and second power signals to the corresponding stator resonator; each corresponding stator resonator is configured for mixing the first and second power signals to produce a mixed power signal and for transmitting the mixed power signal across the electrical gap to the corresponding power signal conversion circuit; and the power signal conversion circuit in its second mode is configured for rectifying and unfolding the mixed and transmitted power signal to produce an output power signal and for transmitting the output power signal to the corresponding rotor coil via the corresponding rotor coil interface. The system controller may be configured for controlling a rotation rate of the rotor by controlling the first and second power signals based on information received by the controller from the rotor coil interfaces.

In the latter embodiment, the first and second power signals produced in each of the switchable power signal modulator/rectifiers may have between them a frequency difference set by the system controller in the corresponding switchable power signal modulator/rectifier based on information communicated from the corresponding rotor coil interface; and the output power signal may be provided by the power signal conversion circuit to the corresponding rotor coil as an AC signal at a frequency of half of the difference frequency.

In the latter embodiment, the first and second power signals produced in each of the switchable power signal modulator/rectifiers may have between them a phase difference set by the system controller in the corresponding switchable power signal modulator/rectifier based on information communicated from the corresponding rotor coil interface; and the output power signal may be provided to the corresponding rotor coil as a DC signal.

In the latter embodiment, the first and second power signals produced in each of the switchable power signal modulator/rectifiers may have between them a phase difference set by the system controller in the corresponding switchable power signal modulator/rectifier based on information communicated from the corresponding rotor coil interface; the corresponding switchable power signal modulator/rectifier may be configured by the system controller to modulate the phase difference at a modulation frequency; and the output signal may be provided to the corresponding rotor coil as an AC power signal at the modulation frequency.

In the latter embodiment, each of the power signal conversion circuits, when in its amplifying mode, may be configured to receive from the corresponding rotor coil a generated power signal and to pass the generated power signal to the corresponding switchable power signal modulator/rectifier; and the corresponding switchable power signal modulator/rectifier, when in its rectifying mode, may be configured to rectify the generated power signal to a converted DC power signal and to provide the converted DC power signal to the DC power source.

In all of the embodiments described herein, each of the one or more bimodal high frequency near-field wireless power transfer links comprises one high frequency stator resonator disposed stationary with respect to the stator and one corresponding high frequency rotor resonator disposed on the rotor for resonant coupling with the high frequency stator resonator at the variable resonant power signal oscillation frequency; each of the high frequency stator resonators is in wired communication with a corresponding high frequency continuous auto-adjusting bimodal transmitter-receiver module, and each of the high frequency rotor resonators is in wired communication with a corresponding high frequency continuous auto-adjusting bimodal transmitter-receiver module on the rotor; and during the rotation of the rotor about the rotor rotation axis one or more high frequency rotor resonators correspond one-at-a-time with each one of the high frequency stator resonators.

In some embodiments, the rotary motor-generator may comprise a single bimodal high frequency near-field wireless power transfer link comprising a single high frequency rotor resonator arranged annularly at a first radius about the rotor rotation axis and a single high frequency stator resonator arranged annularly at a second larger radius about the rotation axis.

In some embodiments, the rotary motor-generator may comprise spaced along the rotor rotation axis a plurality of bimodal high frequency near-field wireless power transfer links each comprising a single high frequency rotor resonator arranged annularly at a first radius about the rotor rotation axis and a single high frequency stator resonator arranged annularly at a second larger radius about the rotation axis.

In some embodiments the rotary motor-generator may comprise a plurality of bimodal high frequency near-field wireless power transfer links wherein a plurality of high frequency rotor resonators is arranged annularly at a first radius about the rotor rotation axis and a plurality of corresponding high frequency stator resonators is arranged annularly at a second larger radius about the rotation axis.

In some embodiments, the rotary motor-generator may comprise a plurality of bimodal high frequency near-field wireless power transfer links wherein a single high frequency rotor resonator is arranged annularly at a first radius about the rotor rotation axis and a plurality of high frequency stator resonators is arranged annularly at a second larger radius about the rotation axis.

In some embodiments, the rotary motor-generator may comprise a plurality of bimodal high frequency near-field wireless power transfer links wherein a first plurality of high frequency rotor resonators is arranged annularly at a first radius about the rotor rotation axis and a plurality of high frequency stator resonators is arranged annularly at a second larger radius about the rotation axis wherein the second plurality is larger in number than the first plurality.

In some embodiments, the rotary motor-generator may comprise one or more bimodal high frequency near-field wireless power transfer links wherein the one or more high frequency rotor resonators are disposed radially symmetrically on a cap end surface of a rotor shaft and each of the one or more corresponding high frequency stator resonators is disposed radially symmetrically about the rotation axis proximate the corresponding high frequency rotor resonator.

In an electric motor-generator having a stator and a rotor disposed to rotate relative to the stator about a rotor rotation axis and wherein the rotor has one or more rotor coils, a method is provided for transferring power between a DC power source and the one or more rotor coils, the method comprising transferring power near-field wirelessly and bimodally at high frequency across an electrical gap between the rotor and a rest of the motor-generator according to an adjustable transfer mode ratio between capacitive power transfer and inductive power transfer at a variable resonant power signal oscillation frequency in one or more bimodal high frequency near-field wireless power transfer links.

To transfer power from the DC power source to the rotor coils, the method may further comprise: placing the electric motor-generator in a motor mode; converting within the one or more bimodal high frequency near-field wireless power transfer links power sourced from the DC power source into high frequency power signals at the power signal oscillation frequency; and receiving in each of the one or more corresponding rotor coils an output power signal via the corresponding one or more bimodal high frequency near-field wireless power transfer links.

Each bimodal high frequency near-field wireless power transfer link may comprise: disposed stationary with respect to the stator a switchable power signal modulator/rectifier in wired communication with the DC power source and with a corresponding stator resonator; disposed on the rotor a power signal conversion circuit in wired communication with a corresponding rotor resonator and with a rotor coil; and the method for transferring power may comprise: switching the switchable power signal conversion circuit to a rectifying and unfolding mode; switching the switchable power signal modulator/rectifier to a modulating mode; producing in the switchable power signal modulator/rectifier from the power sourced from the DC power source first and second power signals having between them one of a frequency difference and a phase difference; mixing the first and second power signals to produce a mixed power signal; transmitting the mixed power signal from the stator resonator to the rotor resonator across the electrical gap; and rectifying and unfolding the mixed power signal in the power signal conversion circuit to produce the output power signal.

Three methods are presented for producing AC or DC signals to be supplied to the rotor coils. The first method comprises establishing between the first and second power signals a difference frequency whereby the output power signal is received in the rotor coil as an AC signal at a frequency of half of the difference frequency. The second method comprises establishing between the first and second power signals a phase difference whereby the output power signal is received in the rotor coil as a DC power signal. The third method comprises establishing between the first and second power signals a phase difference and modulating the phase difference at a modulation frequency, whereby the output power signal is received in the rotor coil as an AC signal having the modulation frequency.

Producing the first and second power signals in each of the power signal modulator/rectifiers may comprise extracting power in the form of the first and second power signals from the DC power source in respectively first and second high frequency switched mode power amplifier/rectifiers by means of respective first and second switching signals provided by a high frequency switching signal generator under control of the system controller.

To transfer power from the rotor coils to the DC power source, the method may further comprise: placing the electric motor-generator in a generator mode; converting within the one or more bimodal high frequency near-field wireless power transfer links power sourced from the one or more corresponding rotor coils into high frequency power signals at the power signal oscillation frequency; and receiving power in the DC power source via the one or more corresponding bimodal high frequency near-field wireless power transfer links.

Each bimodal high frequency near-field wireless power transfer link may comprise: a switchable power signal modulator/rectifier in wired communication with the DC power source and with a stator resonator; and a switchable power signal conversion circuit in wired communication with a rotor resonator and with the rotor coil; and the method for transferring power may further comprise switching the switchable power signal conversion circuits to an amplifying mode; switching the switchable power signal modulator/rectifiers to a rectifying mode; and rectifying in the switchable power signal modulator/rectifiers the power signals sourced from the rotor coil.

Each of the one or more bimodal high frequency near-field wireless power transfer links may comprise: a first high frequency continuous auto-adjusting bimodal transmitter-receiver module disposed stationary with respect to the stator and comprising a first differential self-synchronous radio frequency power amplifier/rectifier; and a second high frequency continuous auto-adjusting bimodal transmitter-receiver module on the rotor and comprising a second differential self-synchronous radio frequency power amplifier/rectifier; wherein the method comprises switching the first differential self-synchronous radio frequency power amplifier/rectifier to a rectifying mode and switching the second differential self-synchronous radio frequency power amplifier/rectifier to an amplifying mode.

Each of the one or more bimodal high frequency near-field wireless power transfer links may comprise: a first high frequency continuous auto-adjusting bimodal transmitter-receiver module disposed stationary with respect to the stator and comprising a first differential self-synchronous radio frequency power amplifier/rectifier; and a second high frequency continuous auto-adjusting bimodal transmitter-receiver module on the rotor and comprising a second differential self-synchronous radio frequency power amplifier/rectifier; wherein the method comprises switching the first differential self-synchronous radio frequency power amplifier/rectifier to an amplifying mode and switching the second differential self-synchronous radio frequency power amplifier/rectifier to a rectifying mode.

The method may further comprise allowing the resonant power signal oscillation frequency in each bimodal high frequency near-field wireless power transfer link to vary freely within a predetermined frequency band according to a load impedance experienced by the bimodal high frequency near-field wireless power transfer link.

In a further aspect, a method is provided for bidirectionally transferring electrical power between a DC power source and a rotor coil of an electric motor-generator configured for operating both as an electric motor and as an electric generator, the method comprising: converting power sourced from one of the DC power source and the rotor coil into a high frequency power signal at a variable resonance frequency in a first continuous auto-adjusting bimodal transmitter-receiver module; transferring by bimodal near-field wireless transmission the high frequency power signal from the first continuous auto-adjusting bimodal transmitter-receiver module to a second continuous auto-adjusting bimodal transmitter-receiver module via a first high frequency resonator disposed on one of a stator and a rotor of the electric motor-generator and a second high frequency resonator disposed on the other of the stator and the rotor of the electric motor-generator; and converting the high frequency power signal received by the second continuous auto-adjusting bimodal transmitter-receiver module into a format compatible with the other of the DC power source and the rotor coil.

The direction of power transfer may be changed by switching at least one differential self-synchronous radio frequency power amplifier/rectifier in the first continuous auto-adjusting bimodal transmitter-receiver module to one of an amplifying mode and a rectifying mode and switching at least one differential self-synchronous radio frequency power amplifier/rectifier in the second continuous auto-adjusting bimodal transmitter-receiver module to the other of the amplifying mode and the rectifying mode.

### BRIEF DESCRIPTION OF DRAWINGS

The abovementioned and other features and objects of this invention, and the manner of attaining them, will become more apparent and the invention itself will be better understood by reference to the following description of an embodiment of the invention taken in conjunction with the accompanying drawings, wherein:

FIG. 1 is a schematic diagram of a generalized bimodal high frequency near-field wireless power transfer link.

FIG. 2 shows a generalized electric motor-generator.

FIG. 3 shows an exploded view of a generalized electric motor-generator.

FIG. 4 shows a generalized rotor of the type employed in the motor-generator of FIG. 3 along with the bearings depicted in FIG. 3, but without cooling fans.

FIG. 5 shows a schematic representation of an embodiment of a bimodal high frequency power transfer system for electrically powering a rotor of a brushless electric motor-generator of the type shown in FIG. 3 by means of a single rotor resonator and a single stator resonator.

FIG. 6 shows a schematic representation of an end on view along a rotation axis of the system shown in FIG. 5.

FIG. 7 is a schematic drawing of an electric motor-generator of which the rotor is powered via a bimodal high frequency power transfer system based on a plurality of pairs of rotor resonators and stator resonators.

FIG. 8 is a schematic drawing of an electric motor-generator of which the rotor is powered via a bimodal high frequency power transfer system with a single power receiving resonator on its rotor and multiple resonators on its stator.

FIG. 9 is a schematic drawing of a generalized electric motor-generator of which the rotor is powered via a bimodal high frequency power transfer system with more power transmitting resonators mounted on its stator than receiving resonators mounted on its rotor.

FIG. 10 is a schematic drawing of an electric motor-generator of which the rotor is powered via a bimodal high frequency power transfer system employing multiple pairs of resonators mounted on the stator and corresponding resonators disposed on an end of its rotor shaft.

FIG. 11 is a schematic drawing of a system for bidirectionally transferring power by means of Near-field Bimodal Wireless Power Transfer between a DC power source and a coil of an electric moto-generator rotor.

FIG. 12 is a flowchart of a method for transferring power bimodally according to an adjustable transfer mode ratio at a variable resonant power signal oscillation frequency.

FIG. 13 is a flowchart of a method for bidirectionally transferring electrical power between a DC power source and a rotor coil of an electric motor-generator configured for operating both as an electric motor and as an electric generator.

FIG. 14 is a schematic drawing of a system for bidirectionally transferring DC or AC power by means of Near-field Bimodal Wireless Power Transfer between a DC power source and a coil of an electric motor-generator rotor.

FIG. 15 is a flow chart for transferring DC or AC power from a DC power source to a rotor coil of an electric motor-generator.

Corresponding reference characters indicate corresponding parts throughout the several views. Although the drawings represent embodiments of the present invention, the drawings are not necessarily to scale and certain features may be exaggerated in order to better illustrate and explain the present invention. The exemplification set out herein illustrates an embodiment of the invention, in one form, and such exemplifications are not to be construed as limiting the scope of the invention in any manner.

### DETAILED DESCRIPTION OF THE INVENTION

The embodiments disclosed below are not intended to be exhaustive or limit the invention to the precise form disclosed in the following detailed description. Rather, the embodiments are chosen and described so that others skilled in the art may utilize its teachings. Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

The focus in this disclosure is on the contactless or brushless transfer of electrical power to coil-based rotors of electrical motor-generators, independent of whether the stators of such motor-generators are based on electrical coils or permanent magnets. In one aspect, this disclosure provides a bimodal high frequency power transfer system for electrically powering a coil-based rotor of a brushless electric motor-generator from a DC power source via a stator of the motor-generator, the rotor and stator each bearing one or more continuous auto-adjusting bimodal transmitter-receiver module (CABT/R module) as defined below, each CABT/R module in wired communication with a corresponding resonator. Bimodal high frequency power transfer is described in detail in Patent Cooperation Treaty Application PCT/IB2023/000167 published on Sep. 21, 2023, as WO2023/175399A2 and will also be addressed below.

The power from the DC source is transferred at a variable HF oscillation frequency from a resonator on the stator to a resonator on the rotor by near-field bimodal wireless power transfer in which the ratio of Capacitive Power Transfer to Inductive Power Transfer is automatically adjusted based on the varying load impedance presented to the CABT/R module on the rotor by at least one rotor coil via its coil signal controller. The transmitting CABT/R module on the stator can automatically adjust the phase, frequency and amplitude of the transmitted power signal in response to a variety of inputs from various sensors.

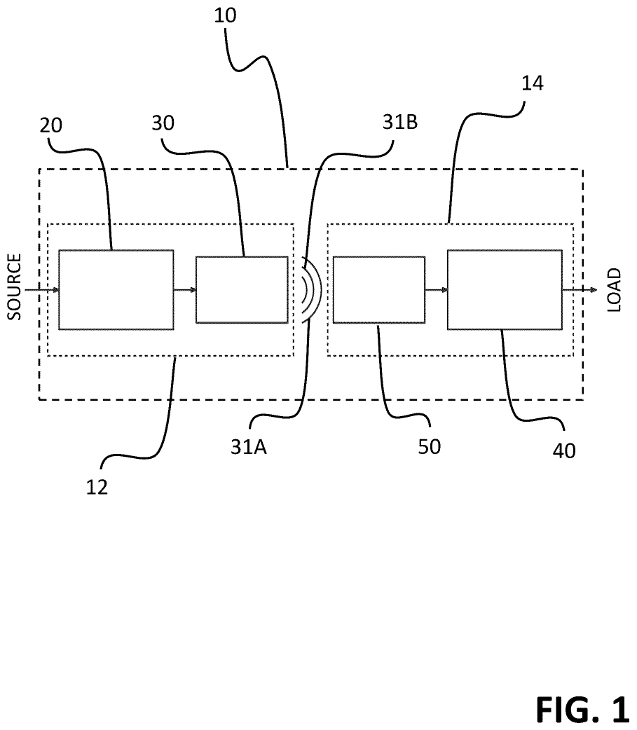

FIG. 1 shows a generalized bimodal high frequency near-field wireless power transfer link system 10, having primary/transmit/send side 12 and secondary/receive side 14. FIG. 1, including the details of its component subassemblies, is described in detail in publication WO2023/175399A2. With reference to FIG. 1, the term “Continuous Auto-adjusting Bimodal Transmitter-Receiver Module” (CABT/R module) is used herein to refer to transmitter-receiver module 20 that, when in transmit mode, continuously adjusts the ratio of Capacitive Power Transfer to Inductive Power Transfer. The power transfer in this situation is from first (transmitter) resonator 30 connected to transmitter-receiver module 20 to second separate (receiver) resonator 50. The adjusting is on the basis of changes in a load experienced by CABT/R module 20 via first and second resonators 30 and 50 and/or based on signals from sensors. Second CABT/R module 40 may be configured in a receive mode to receive the above signal from second (receiver) resonator 50 and process it to receiver side 14 output signal to a load. Transmit side CABT/R module 20 may obtain its power from a suitable source. It is important to understand that the power transfer from resonator 30 to resonator 40 is via both magnetic field 31A and electric field 31B between the two resonators.

CABT/R 20 and CABT/R 40 may be identical and may both be connected to their respective resonators 30 and 50 in exactly the same way, the only difference being that CABT/R 20 is also in wired communication with the power source, while CABT/R 40 is in wired communication with the load. To the extent that bimodal high frequency near-field wireless power transfer link 10 is therefore electronically mirror-symmetrical as regards send side 12 and receive side 14, bimodal high frequency near-field wireless power transfer link 10 may transfer power in either direction. When CABT/R 20 is switched to send mode, CABT/R 40 is switched to receive mode to allow transfer of power from the source to the load. When CABT/R 20 is switched to receive mode, CABT/R 40 is switched to send mode to allow transfer of power from the load to the source. The mode-switching is based on the use of differential self-synchronous radio frequency power amplifier/rectifiers in CABT/R 20 and CABT/R 40. In the interest of brevity, such a bimodal power transfer near-field transfer shall be referred to as a “bimodal wireless link”.

The adjective term “bimodal” is used herein to describe a system configured for simultaneous capacitive signal transfer and inductive signal transfer at a resonance frequency from a transmitter resonator to a receiver resonator, the capacitive signal transfer being on the basis of resonant capacitive coupling between a capacitance in the transmitter resonator and a capacitance in the receiver resonator and the inductive signal transfer being on the basis of resonant inductive coupling between an inductance in the transmitter resonator and an inductance in the receiver resonator. In such “bimodal” power transfer the nature of the power transfer can vary on a continuous scale from purely Inductive Power Transfer (IPT) to purely Capacitive Power Transfer (CPT) so that there is at any instant in time during the power transfer a ratio of CPT to IPT.

Bimodal signal transfer in its definition as employed in the present disclosure is not to be confused with the well-known purely resonant inductive signal transfer in which the transmitter employs a capacitance to establish resonance in an inductor in the transmitter and the receiver similarly employs a capacitance to establish resonance in an inductor in the receiver, but in which the two aforementioned capacitances are not in direct electric field communication with each other. Notwithstanding the involvement of capacitance in establishing the resonance, this latter form of prior art signal transfer is purely by inductive coupling. “Bimodal” signal transfer is also not to be confused with purely inductive signal transfer that is conducted simultaneously with non-resonant capacitive signal transfer via a separate channel employing capacitances that are not resonating with the inductors in the transmitter and receiver. To be clear, bimodal signal transfer in its definition as employed in the present disclosure shall mean that inductive elements in a transmitter resonator communicate via magnetic field with inductive elements in a receiver resonator and capacitive elements in the same transmitter resonator communicate via electric field with capacitive elements in the same receiver resonator.

Bimodal signal transfer by means of system 10 of FIG. 1 is described in detail in publication WO2023/175399A2. The CABT/R modules and resonators employed in the present disclosure are based on the transmitter-receiver modules and resonators disclosed in detail in publication WO2023/175399A2. The CABT/R modules and resonators along with aspects of bimodal power transfer will be addressed in more detail below after first considering at systems level the application of near-field bimodal wireless power transfer to electric motor-generators having coil-based rotors.

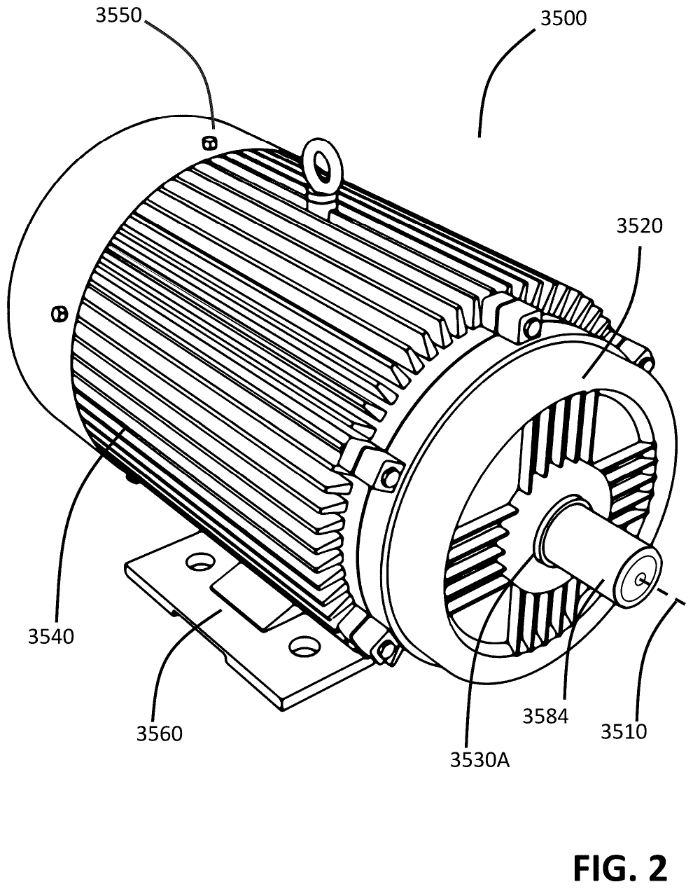

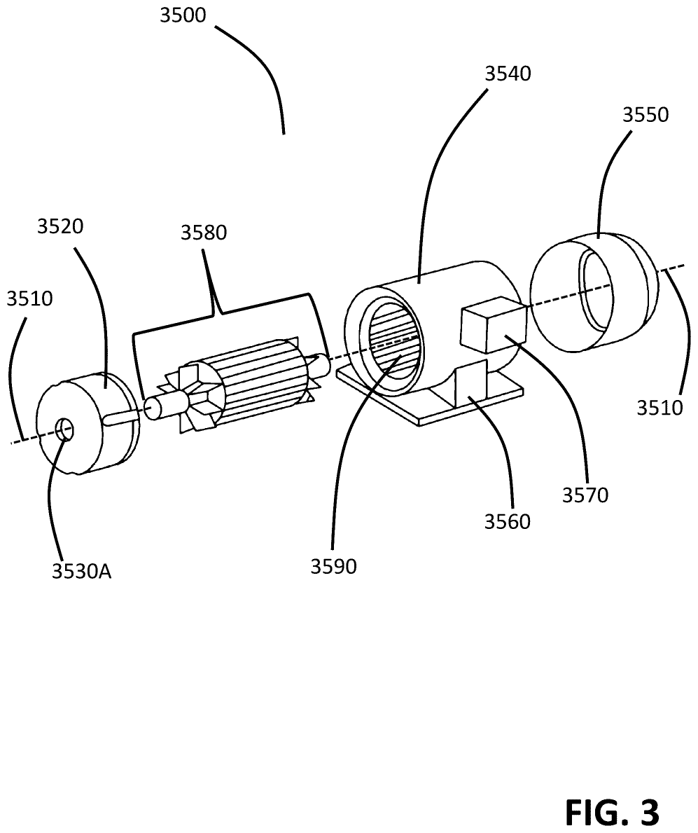

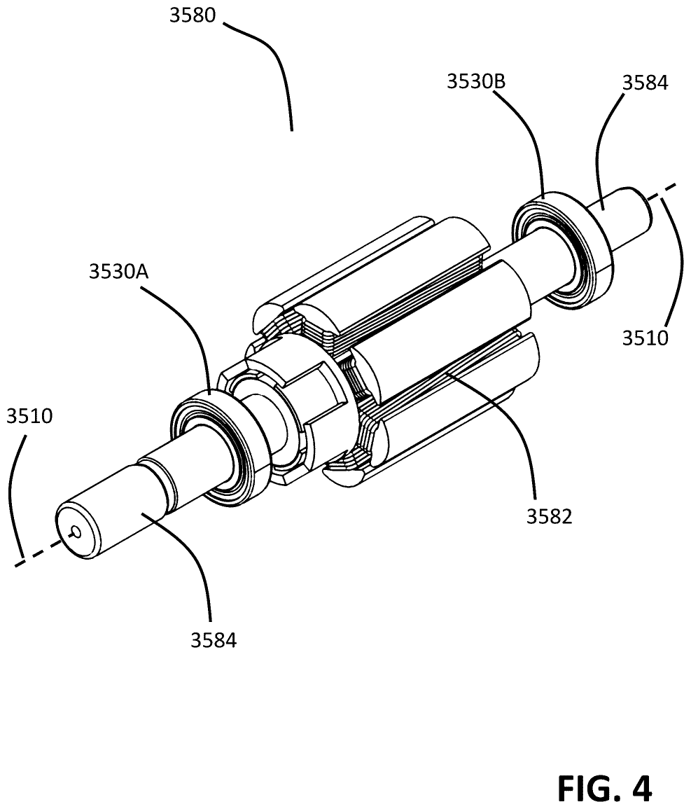

FIG. 2 shows a generalized brushless electric motor-generator 3500. The major externally visible elements of motor-generator 3500 include front and rear end caps 3520 and 3550, motor housing 3540, typically with cooling vanes, mount 3560, front and rear bearings 3530A and 3530B (obscured in FIG. 2 but shown in FIG. 3), and rotor shaft 3584 rotating about a longitudinal rotation axis 3510 within bearings 3530A and 3530B. Rotor shaft 3584 is the only portion of rotor 3580 (shown in FIGS. 3 and 4) visible in FIG. 2.

FIG. 3 shows an exploded view of a generalized electric motor-generator of the brushless type sharing the elements of the motor-generator of FIG. 2. Terminal box 3570 for external electrical connections is obscured in FIG. 2 but visible in FIG. 3. FIG. 3 also schematically shows stator 3590 with one or more stator coils inside motor housing 3540. Rotor 3580 is shown bearing cooling fans, rotor 3580 being arranged to rotate about rotation axis 3510.

FIG. 4 shows rotor 3580 in more detail, with front and rear bearings 3530A and 3530B mounted annularly around rotor shaft 3584, but without the cooling fans. A plurality of rotor coils 3582 is shown.

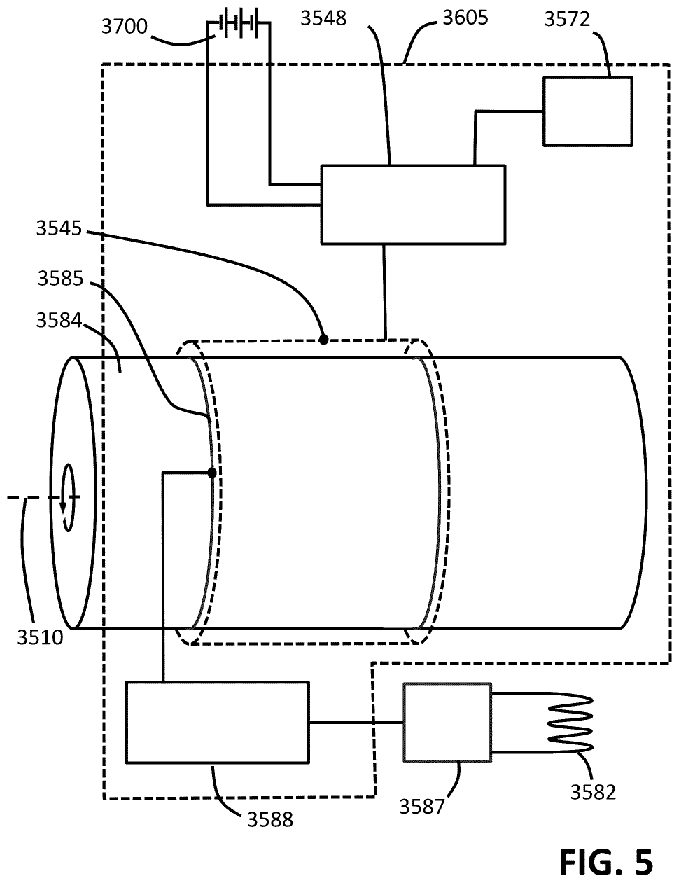

Five different embodiments of stator-to-rotor bimodal near-field wireless power transfer within electric motor-generators using coil-based rotors will now be described with reference to FIGS. 5 to 10. In each of these five embodiments, power transfer is described from a battery to CABT/R modules disposed on rotor 3580. From there, power is transferred to one or more industrial coil signal controllers 3587. It is left to the coil signal controller(s) to provide suitably timed and shaped power signals to various rotor coils 3582. In four of the five embodiments, receiver resonators are disposed annularly on the cylindrical surface of rotor shaft 3584, or a concentric surface of greater radius attached to rotor shaft 3584, with transmitter resonators disposed annularly on stator 3590 facing the rotor resonators. In a fifth embodiment, the receiver resonators are disposed annularly about rotation axis 3510 at different radii on the end-face of rotor shaft 3584. The corresponding transmitter resonators are disposed on an end cap of stator 3590 and facing the receiver resonators. In all five embodiments, the CABT/R modules play no direct role in the timing of signals to rotor coils 3582.

FIG. 5 shows a purely schematic representation of bimodal high frequency power transfer system 3605 for transferring electrical power from DC power source 3700 to rotor coil 3582 of brushless electric motor-generator 3500 of the type shown in FIGS. 1 to 3. None of the elements are to scale. In order to avoid obfuscating clutter, the three-dimensional structure of motor housing 3540 and stator 3590 are not shown in FIG. 5. Stators, for example stator 3590 of FIG. 2, and rotor coils, for example rotor coil 3582 of FIG. 3, are well known and understood and no constructive purpose is served here by dwelling on these well-established industrial elements of electric motor-generators.

The focus in this disclosure is on the transfer of electrical power from DC source 3700, via CABT/R module 3548 mounted on or in motor housing 3540 of FIGS. 1 and 2, through resonator 3545 mounted on stator 3590 in annular fashion at a first radius about rotation axis 3510, to resonator 3585 mounted on rotor 3580 proximate resonator 3545. Resonator 3545 is shown in broken lines so as to not obscure resonator 3585. In some embodiments, there may be a plurality of resonators 3585 mounted on rotor 3580 along the length of rotor 3580 and a corresponding plurality of resonators 3545 mounted on stator 3590, facing the plurality of corresponding resonators 3585 mounted on rotor 3580. Since the arrangements of such pairs of resonators would be largely identical, we show only one resonator pair in FIG. 5.

The term “stator resonator” is employed herein to refer to those resonators mounted to stator 3590. The term “rotor resonator” is employed herein to refer to those resonators mounted to rotor 3580. The term “stator CABT/R module” is employed herein to refer to a CABT/R module in wired communication with a “stator resonator”. The term “rotor CABT/R module” is employed herein to refer to a CABT/R module in wired communication with a “rotor resonator”.

By virtue of symmetry about rotation axis 3510, as rotor shaft 3584 rotates, rotor resonator 3585 remains facing stationary stator resonator 3545 within a nominally constant radial separation between rotor resonator 3585 and stator resonator 3545. The near-field bimodal wireless power transfer process described herein then takes place continuously from stator resonator 3545 to rotor resonator 3585. Rotor resonator 3585 is in wired communication with rotor CABT/R module 3588, which is configured in a receiver mode. From rotor CABT/R module 3588 the transferred power is provided to rotor coil 3582 on rotor 3580 via a suitable coil signal controller 3587. In the present embodiment, coil signal controller 3587 may be a standard industrial controller, for example without limitation, a Variable Frequency Drive suitable for driving a rotor coil of an industrial electric motor-generator. Such controllers are well-known and will not be described further here. Suffice it to record here that one of the key roles of a standard industrial controller for an electric motor, whether a VDF or not, is to manage the frequency of power signals supplied to rotor coil 3582 in view of the so-called “slip” in the motor. “Slip” is usually expressed as a percentage difference between the frequency of the power signal applied to the motor and the actual resulting rotor rotation frequency. While “slip” may be viewed as a negative effect, it actually plays a major role in accelerating electric motors. Depending on the type of electric motor-generator, coil signal controller 3587 may be a single coil signal controller controlling a plurality of coils 3582. In other embodiments there may be separate coil signal controller 3587 for each rotor coil 3582.

While each CABT/R module in system 3605 may have its own internal controller as per publication WO2023/175399A2, the system as a whole is controlled by system controller 3572. All stator CABT/R modules are in wired communication with system controller 3572. Circuit power supply cabling to system controller 3572 is not shown in FIG. 5. Such power may, for example, be obtained from DC power supply 3700 and may be routed via terminal box 3570 (see FIG. 2) in which system controller 3572 may also be housed.

In FIG. 5, resonator 3585 is shown mounted directly to rotor shaft 3584, but in some embodiments, resonator 3585 may be mounted annularly on a larger diameter disk on rotor shaft 3584 or on the same area of the rotor as rotor coils 3582 of FIG. 3.

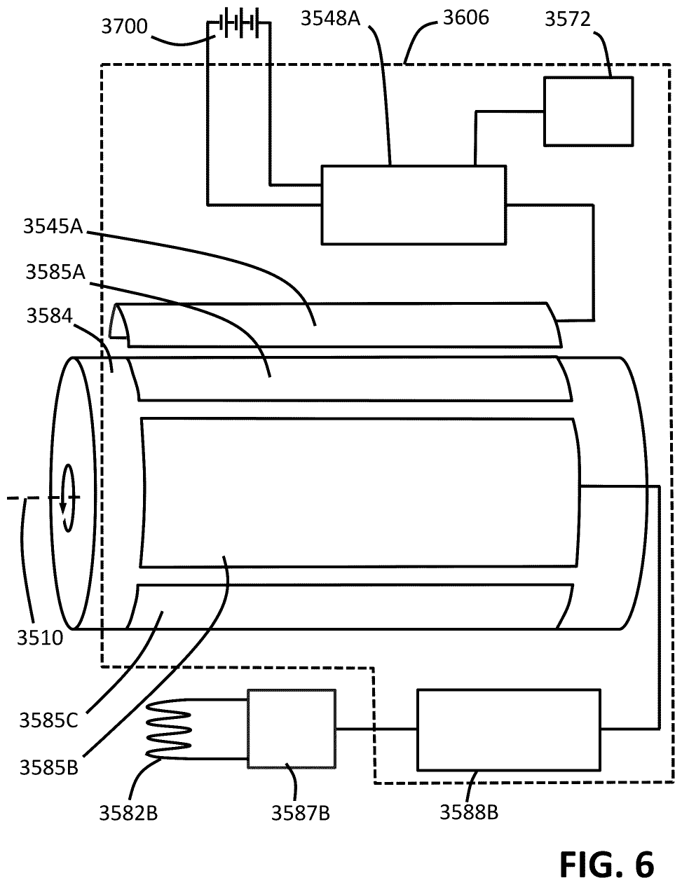

FIG. 6 shows a purely schematic representation of bimodal high frequency power transfer system 3606 for transferring electrical power from DC power source 3700 to rotor coil 3582B of brushless electric motor-generator 3500 of the type shown in FIG. 3. None of the elements are drawn to scale. As with FIG. 4, the three-dimensional structure of motor housing 3540 and stator 3590 are not shown in FIG. 6 for reasons already noted.

The focus in FIG. 6 is on the transfer of electrical power from DC source 3700, via CABT/R module 3548A mounted on or in motor housing 3540 of FIGS. 1 and 2, through resonator 3545A mounted on stator 3590 in annular fashion at a first radius about rotation axis 3510, to resonator 3585A mounted on rotor 3580 proximate and facing resonator 3545A. In FIG. 6, rotor 3580, of which only rotor shaft 3584 is shown, is depicted as having four mounted resonators 3585A, 3585B, and 3585C (with fourth resonator 3585D obscured by rotor shaft 3584). These last four resonators are mounted on rotor 3580 in annular fashion about rotation axis 3510 at a second radius. In some embodiments, there may be a larger plurality of resonators mounted on rotor 3580 and a correspondingly larger plurality of resonators mounted on stator 3590. The second radius is smaller than the first radius to allow a rotor resonator facing a stator resonator to resonantly couple with the facing stator resonator.

Due to the difficulty of simultaneously clearly conveying in the two dimensions of FIG. 6 both the nature of the elements of rotor resonator 3585A and its juxtaposition with respect to stator resonator 3545A, rotor resonator 3585B, which is identical to rotor resonator 3585A, is selected for more detailed description. When rotor 3580 rotates to place rotor resonator 3585B instead of rotor resonator 3585A proximate stator resonator 3545A, stator resonator 3545A couples with rotor resonator 3585B instead of rotor resonator 3585A. The near-field bimodal wireless power transfer process described herein then takes place from stator resonator 3545A to rotor resonator 3585B, which is in wired communication with rotor CABT/R module 3588B, which is configured in a receiver mode. From rotor CABT/R module 3588B the transferred power is provided to a rotor coil 3582B on rotor 3580 via a suitable coil signal controller 3587B.

Depending on the type of electric motor-generator, coil signal controller 3587B may be a single coil signal controller controlling all four coils 3582A, 3582B, 3582C and 3582D, or there may be separate coil signal controllers 3587A, 3587B, 3587C and 3587D for each of rotor coils 3582A, 3582B, 3582C and 3582D respectively to provide the correctly timed and shaped drive signals to the rotor coils. While each CABT/R module in system 3606 may have its own internal controller as per publication WO2023/175399A2, the system as a whole is controlled by system controller 3572. All stator CABT/R modules are in wired communication with system controller 3572; though, to avoid clutter, only stator CABT/R module 3548A is shown in FIG. 6. Circuit power supply cabling to system controller 3572 is not shown in FIG. 6. Such power may, for example, be obtained from DC power supply 3700 and may be routed via terminal box 3570 (see FIG. 2) in which system controller 3572 may also be housed.

In FIG. 6, the rotor resonators are shown mounted directly to rotor shaft 3584, but in some embodiments, the rotor resonators may be mounted annularly on a larger diameter disk on rotor shaft 3584 or on the same area of the rotor as rotor coils 3582 of FIG. 3. In such embodiments, the stator resonators are disposed annularly about rotation axis 3510 at a larger radius than the rotor resonators.

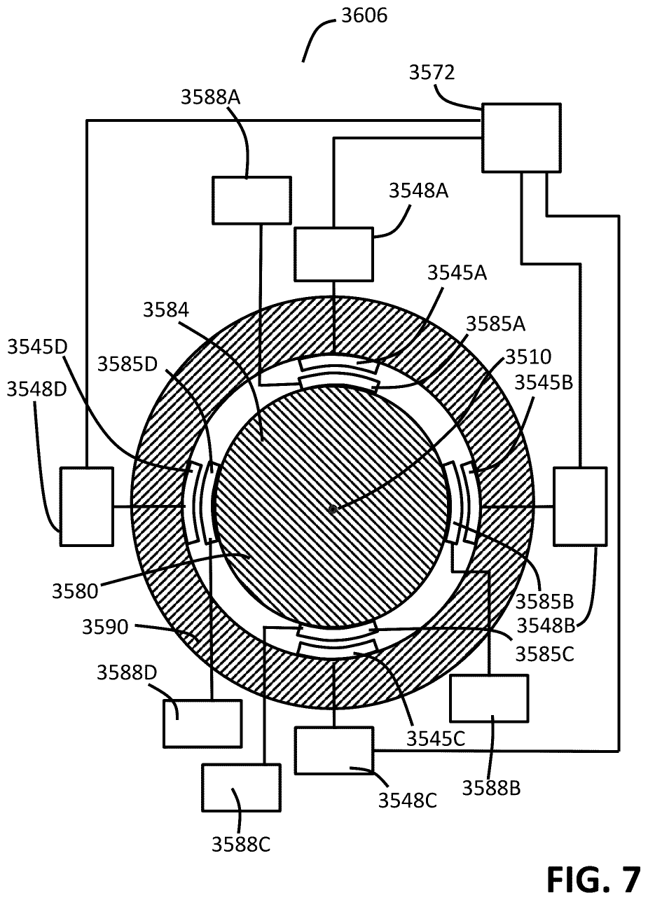

FIG. 7, which is an end-on axial view of the system of FIG. 6, shows four stator resonators 3545A, 3545B, 3545C and 3545D mounted annularly on stator 3590 and matching corresponding four rotor resonators 3585A, 3585B, 3585C and 3585D disposed annularly on rotor 3580. Each rotor resonator 3585A, 3585B, 3585C and 3585D may be in wired communication with its own corresponding rotor CABT/R module, 3588A, 3588B, 3888C and 3588D. To avoid cluttering FIG. 7, the corresponding coil signal controller(s) and coil(s) are not shown and should be understood as functioning as with FIG. 6. Each stator resonator 3545A, 3545B, 3545C and 3545D is in wired communication with corresponding stator CABT/R module 3548A, 3548B, 3548C and 3548D. Each of stator CABT/R modules 3548A, 3548B, 3548C and 3548D obtains DC power from DC power source 3700 of FIG. 6. DC power source 3700 is not shown in FIG. 7 in order to avoid clutter. Though all CABT/R modules in system 3606 have their own internal controllers as described in published Patent Cooperation Treaty Application WO2023/175399A2, the HF power output signals of stator CABT/R modules 3548A, 3548B, 3848C and 3548D may all be coordinated by system controller 3572. Only four resonators are shown on each of stator 3590 and rotor 3580, but in a general embodiment of this type there may be any plurality of equal numbers of corresponding resonators on stator 3590 and rotor 3580.

In the embodiment shown in FIGS. 6 and 7, system controller 3572 ensures that signals separately applied to stator resonators 3545A, 3545B, 3545C and 3545D are timed to coincide with the passage of each of rotor resonators 3585A, 3585B, 3585C and 3585D past each of stator resonators 3545A, 3545B, 3545C and 3545D. A gap is present between rotor resonators 3585A, 3585B, 3585C and 3585D and stator resonators 3545A, 3545B, 3545C and 3545D, and although that gap appears as a free space in the illustrations, those of skill in this art will recognize that the gap is an electrical gap, in which there may be little or no space between the physical embodiments of rotor resonators 3585A, 3585B, 3585C and 3585D and stator resonators 3545A, 3545B, 3545C and 3545D. By monitoring the impedance sensed by CABT/R modules 3548A, 3548B, 3848C and 3548D, system controller 3572 ensures that the power signal pulse imparted to each of rotor resonators 3585A, 3585B, 3585C and 3585D by each of stator resonators 3545A, 3545B, 3545C and 3545D has the appropriate pulse width, pulse shape, pulse amplitude, and pulse phase or timing. These parameters are all under the collective coordinating control of system controller 3572 that provides the appropriate switching signals to stator CABT/R modules 3548A, 3548B, 3848C and 3548D. Circuit power supply cabling to system controller 3572 is not shown in FIG. 7.

Each of rotor resonators 3585A, 3585B, 3585C and 3585D provides its received power HF signal to its corresponding rotor CABT/R module 3588A, 3588B, 3888C and 3588D, which in turn provides its processed power as a pulsed DC signal to the corresponding coil signal controller(s). While as already explained, depending on the type of electric motor-generator, there may be a single coil signal controller controlling all rotor coils, or there may be a separate coil signal controllers for each rotor coil. In the embodiment of FIGS. 6 and 7, CABT/R modules 3588A, 3588B, 3888C and 3588D supply to the coil signal controller(s) the power as-received and processed. In this embodiment it is left to the coil signal controller(s) to render power to the rotor coils in the form that may be required by the rotor coils.

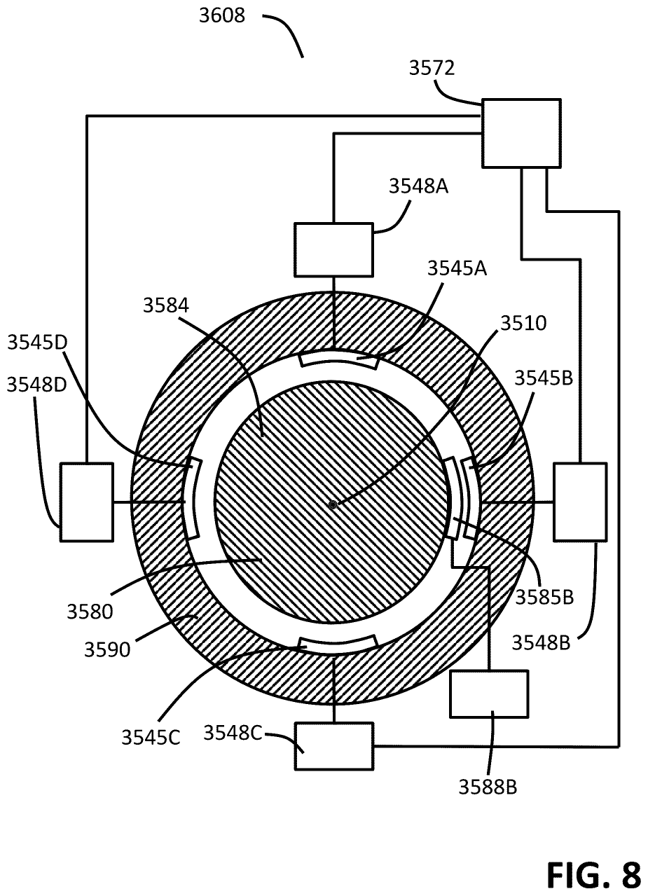

In one embodiment, shown in FIG. 8 as system 3608, a single rotor resonator, for example rotor resonator 3585B, is disposed on rotor 3580, and power is transferred to it sequentially, one at a time, by a plurality of stator resonators 3545A, 3545B, 3545C and 3545D disposed annularly about rotor 3580 on stator 3590. As with the implementation of FIGS. 6 and 7, each stator resonator 3545A, 3545B, 3545C and 3545D may have its own corresponding stator CABT/R module, 3548A, 3548B, 3848C and 3548D, though CABT/R modules 3548A, 3548B, 3848C and 3548D may all be coordinated by system controller 3572 and get their power from DC source 3700 shown in FIGS. 5 and 6 (not shown in FIG. 8). In this embodiment, for the sake of clarity, only four resonators 3545A, 3545B, 3545C and 3545D are shown disposed annularly about rotor 3580 on stator 3590, but there may instead be a larger plurality of resonators on stator 3590. Each of stator CABT/R modules 3548A, 3548B, 3548C and 3548D is in wired communication with DC power source 3700. To avoid cluttering in FIG. 8, corresponding coil signal controller(s) and coil(s) are not shown. It is left to the coil signal controller to provide the correctly timed and shaped drive signals to any rotor coils connected to it.

In the embodiment shown in FIG. 8, system controller 3572 ensures that signals separately applied to stator resonators 3545A, 3545B, 3545C and 3545D are timed to coincide with the passage of rotor resonator 3585B past each of stator resonators 3545A, 3545B, 3545C and 3545D. By monitoring the impedance sensed by CABT/R modules 3548A, 3548B, 3848C and 3548D, system controller 3572 ensures that the power signal pulse imparted to rotor resonator 3585B by each of stator resonators 3545A, 3545B, 3545C and 3545D has the appropriate pulse width, pulse shape, pulse amplitude, and pulse phase or timing. These parameters are all under the joint coordinating control of system controller 3572 that provides the appropriate switching signals to stator CABT/R modules 3548A, 3548B, 3848C and 3548D. Circuit power supply cabling to system controller 3572 is not shown in FIG. 8. Such power may, for example, be obtained from DC power supply 3700 and may be routed via terminal box 3570 (see FIG. 2) in which system controller 3572 may also be housed. Rotor resonator 3585B provides its received power HF signal to its corresponding rotor CABT/R module 3588B, which in turn provides power to the corresponding coil signal controller which then controls the power signals applied to the coils of the rotor.

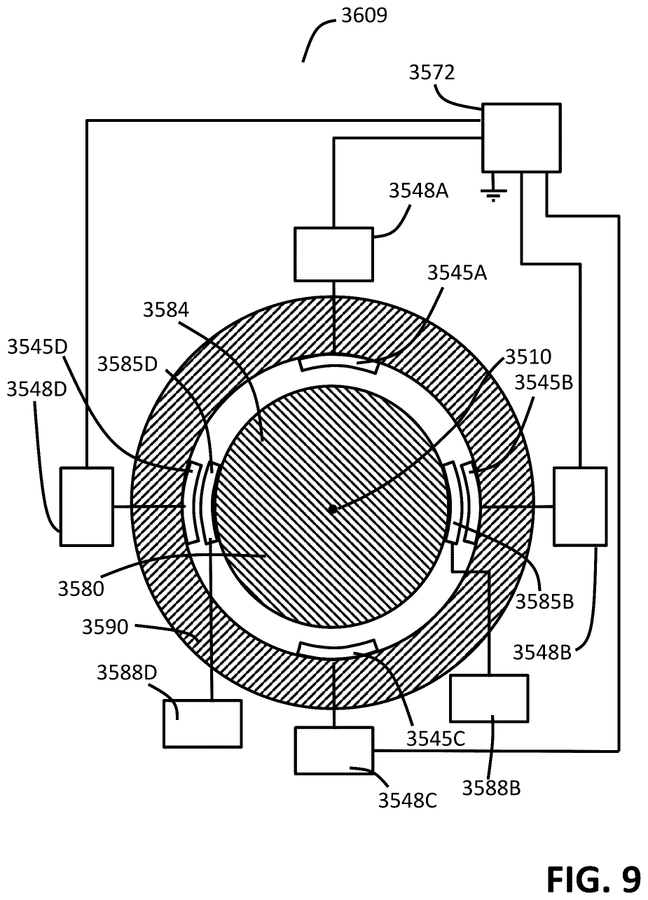

In one embodiment, shown in FIG. 9 as system 3609, a plurality of rotor resonators, for example two rotor resonators 3585B and 3585D, are disposed on rotor 3580, and power is transferred to rotor resonators 3585B and 3585D sequentially by a plurality of stator resonators 3545A, 3545B, 3545C and 3545D disposed annularly about rotor 3580 on stator 3590. As with the embodiment shown in FIG. 8, each stator resonator 3545A, 3545B, 3545C and 3545D is in wired communication with its own corresponding stator CABT/R module, 3548A, 3548B, 3848C and 3548D. Stator CABT/R modules 3548A, 3548B, 3848C and 3548D are all coordinated by system controller 3572 and get their power from DC source 3700. For the sake of clarity, only four stator resonators 3545A, 3545B, 3545C and 3545D are shown disposed annularly about rotor 3580 on stator 3590, but there may instead be a larger first plurality of stator resonators on stator 3590 and a second plurality of rotor resonators on the rotor. In this embodiment, the second plurality is smaller in number than the first plurality.

In the embodiment shown in FIG. 9, system controller 3572 ensures that signals separately applied to resonators 3545A, 3545B, 3545C and 3545D are timed to coincide with the passage of resonators 3585B and 3585D past each of resonators 3545A, 3545B, 3545C and 3545D. To ensure that the power signal pulses imparted to rotor resonators 3585B and 3585D by each of resonators 3545A, 3545B, 3545C and 3545D has the appropriate pulse width, pulse shape, pulse amplitude, and pulse phase or timing, these parameters are all under the control of system controller 3572 that provides the appropriate switching signals to CABT/R modules 3548A, 3548B, 3848C and 3548D. Circuit power supply cabling to system controller 3572 is not shown in FIG. 9. Such power may, for example, be obtained from DC power supply 3700 and may be routed via terminal box 3570 (see FIG. 2) in which system controller 3572 may also be housed.

Rotor resonators 3585B and 3585D provide their received power HF signal to their corresponding rotor CABT/R modules 3588B and 3588D, which in turn provide power to the coil signal controller(s), which then provide(s) the correctly timed and shaped drive signals to any rotor coils connected to it/them.

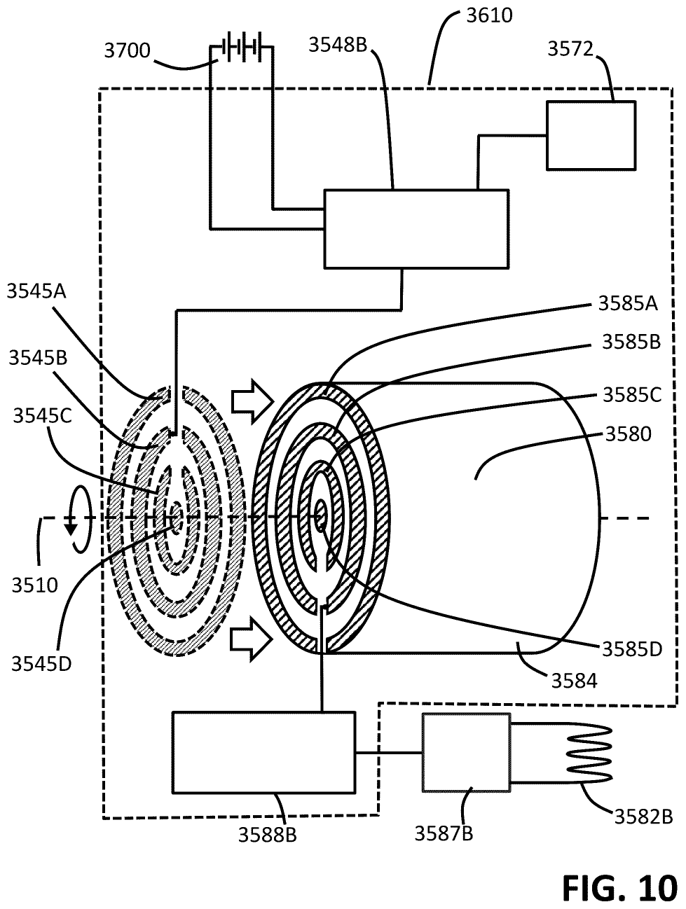

In a further embodiment shown schematically in FIG. 10, system 3610 comprises the same resonator and CABT/R module elements with the same functions as the resonators and CABT/R module elements of system 3606 of FIGS. 6 and 7, but the elements are shaped and disposed differently. In system 3610, rotor resonators 3585A, 3585B, 3585C and 3585D are circular and are arranged coplanar and concentrically about rotation axis 3510 on a flat end surface of rotor shaft 3584. In some embodiments a larger rotary disc may be attached to the end of shaft 3584 and rotor resonators 3585A, 3585B, 3585C and 3585D disposed on the larger rotary disc. Stator resonators 3545A, 3545B, 3545C and 3545D are disposed in a fixed position on a stationary extension to end cap 3520 of FIG. 3 (not shown in FIG. 10). As rotor 3580 rotates, rotor resonators 3585A, 3585B, 3585C and 3585D maintain their orientation with respect to stator resonators 3545A, 3545B, 3545C and 3545D and bimodal near-field power transfer may be maintained on a substantially constant basis between each of rotor resonators 3585A, 3585B, 3585C and 3585D and its corresponding stator resonators 3585A, 3585B, 3585C and 3585D.

As in the previous embodiments, stator resonators 3585A, 3585B, 3585C and 3585D are driven by stator CABT/R modules, all coordinated by system controller 3572 and the stator CABT/R modules get their power from DC source 3700. To avoid clutter in FIG. 10, only one stator CABT/R module 3548B is shown in wired electrical communication with stator resonator 3545B. Similarly, FIG. 10 shows only corresponding rotor CABT/R module 3588B in wired electrical communication with rotor resonator 3585B facing stator resonator 3545B. Single coil signal controller 3587B is shown in wired communication with rotor CABT/R module 3588B. Coil signal controller 3587B provides the correctly timed and shaped drive signals to any rotor coil 3582B connected to it. In some embodiments, all the rotor CABT/R modules provide their power signals to a single coil signal controller, which then provides the correctly timed and shaped power signals to all the different rotor coils. In other embodiments, each rotor CABT/R module provides its power to a separate coil signal controller which is in turn dedicated to an individual coil on the rotor.

All required timing and frequency information may be supplied from system controller 3572 over the near-field wireless power transfer link as described below or via the other means of communication described in the following sections.

When implemented, for example without limitation, in an electric vehicle, the systems of FIGS. 5 to 10, in addition to being useful in driving rotor 3580 of electric motor-generator 3500 with power from DC power source 3700, which in this implementation may be a battery pack, the exact same system in each of FIGS. 5 to 10 may operate as a system for transferring power from motor-generator 3500 functioning as an electrical generator, the system transferring the power as DC power to battery 3700 to charge battery 3700. When operating in this reverse mode, the differential self-synchronous radio frequency power amplifier/rectifier(s) of CABT/R 3548, 3548A, 3548B, 3548C, 3548D are switched to rectifying mode while the differential self-synchronous radio frequency power amplifier/rectifier(s) of CABT/R 3588, 3588A, 3588B, 3588C, 3588D are switched to amplifying mode. The resulting reverse transmission of power may pertain when the vehicle is braking, or is proceeding without power being applied from DC power source (battery pack) 3700. Systems 3605, 3606, 3608, 3609, 3610 of FIGS. 5 to 10 are therefore fully bidirectional and are capable of transferring power in either direction between DC power source 3700 and rotor coils 3582, 3582A, 3582B, 3582C, 3582D.

Returning now to FIG. 1 to consider bimodal near-field power transfer more closely, it is noted from publication WO2023/175399A2 that each of transmitter resonator 30 and receiver resonator 50 may comprise one or more antennas arranged in various configurations. A variety of suitable antennas for resonators 30 and 50 is described in publication WO2023/175399A2. The suitable antennas all have in common a high self-inductance and a high self-capacitance that is capable of creating both magnetic field 31A and electric field 31B (separately and/or simultaneously) for the purpose of CPT and IPT. For the purposes herein, a “high self-inductance” is a self-inductance that is sufficiently great to allow the antenna to generate a magnetic field suitable for the purposes of IPT. Similarly, for the purposes herein “high self-capacitance” is a self-capacitance that is sufficiently great to allow the antenna to generate an electric field suitable for the purposes of CPT. Methods and designs for achieving high self-capacitance and high self-inductance in such antennas, including multilayer antennas, are described in WO2023/175399A2 and will not be further described herein.

In FIG. 1, transmit side CABT/R module 20 may comprise an oscillator, power amplifier, filter network, matching network, compensation network and a V-I (voltage-current) tuner, along with an internal controller to control these elements. In addition, transmit side CABT/R module 20 comprises sensors, including a load detector, a transmitted power sensor, a surrounding object detector and a distance detector. The internal controller is configured to receive various inputs from the various sensors and output control signals to the various listed components of transmit side CABT/R module 20. As explained in detail in WO2023/175399A2, transmit side CABT/R module 20 is capable of adjusting the ratio of CPT to IPT between 0 and 100% on a continuous scale. Transmit side CABT/R module 20 is capable of adjusting both the phase and the frequency of a power signal supplied to resonator 30 based on the behavior of any load coupled to receiver resonator 50. Transmit side CABT/R module 20 is capable of sensing that load on the receiver resonator 50 via the resonant coupling between resonators 30 and 50.

Transmit side CABT/R module 20 receives, as input, power comprising, for example, direct current (DC) power. Transmit side CABT/R module 20 delivers, as output, power comprising, for example, alternating current (AC) power at high frequency (HF) to transmitter resonator 30.

Transmitter resonator 30 receives, as input, power from transmit side CABT/R module 20 and may output magnetic field 31A (for example, a time-varying magnetic field) and/or electric field 31B (for example, a time-varying electric field). In some embodiments, transmitter resonator 30 outputs magnetic field 31A for the purpose of IPT. In some embodiments, transmitter resonator 30 outputs electric field 31B for the purpose of CPT. In some embodiments, resonator 30 simultaneously outputs magnetic field 31A and electric field 31B for the purpose of simultaneous transfer of power through CPT and IPT. In some embodiments, resonator 30 may switch between outputting electric field 31B for the purpose of CPT, outputting magnetic field 31A for the purpose of IPT and simultaneously outputting magnetic field 31A and electric field 31B for the purpose of simultaneous transfer of power through CPT and IPT.

In the presence of magnetic field 31A, a current may be induced in receiver resonator 50 for the purpose of IPT. In the presence of electric field 31B, an alternating potential may be induced on receiver resonator 50 (or one or more antennas thereof). When a current is induced in receiver resonator 50 by magnetic field 31A, such current may be outputted to receive side CABT/R module 40. Similarly, when an alternating potential is induced on receiver resonator 50 by electric field 31B, a current may be caused to flow into receive side CABT/R module 40 by receiver resonator 50.

Receive side CABT/R module 40 may receive, as input, from receiver resonator 50 power and may output power to a load. In some embodiments the load may be a DC load. In other embodiments the load may be an AC load. By way of non-limiting example, the load may be a rotor coil of a rotor of an electric motor-generator, for example electric motor-generator 3500 of FIGS. 2 and 3.

Bimodal high frequency near-field wireless power transfer link 10 may be configured to adjust a ratio of power transferred from transmit side CABT/R module 20 to receive side CABT/R module 40 via CPT to power transferred by transmit side CABT/R module 20 to receive side CABT/R module 40 via IPT (the “transfer mode ratio”), for various reasons. For example, the transfer mode ratio may be adjusted to increase a proportion of power delivered by CPT when alignment between transmitter resonator 30 and receiver resonator 50 worsens.

In some embodiments, the transfer mode ratio may be adjusted according to a maximum power point tracking technique such as, but not limited to, “observe and perturb” as is sometimes employed for wind turbines and solar panels (see, for example, S. Dehghani, S. Abbasian and T. Johnson, “Adjustable Load With Tracking Loop to Improve RF Rectifier Efficiency Under Variable RF Input Power Conditions,” in IEEE Transactions on Microwave Theory and Techniques, vol. 64, no. 2, pp. 343-352, February 2016). In some embodiments, the transfer mode ratio may be adjusted according to a machine learned algorithm. For example, in some embodiments, if bimodal high frequency near-field wireless power transfer link 10 determines that a power transfer efficiency is undesirably low, bimodal high frequency near-field wireless power transfer link 10 may increase a proportion of power delivered by CPT (or IPT). If the power transfer efficiency is negatively impacted by increasing reliance on CPT (or IPT), then Bimodal high frequency near-field wireless power transfer link 10 may decrease the reliance on CPT (or IPT). This process may be repeated iteratively until a desirable/maximum power transfer efficiency is attained.

In some embodiments, there may be a need for power to be transmitted at certain times in the reverse direction, that is, from the load side to the source side of FIG. 1. The ability of both CABT/R module 20 and CABT/R module 40 to be reconfigured between operating in transmitter mode and receiver mode allows such transfer of power in the “reverse” direction from CABT/R module 40 to CABT/R module 20. The system therefore allows bidirectional power transfer. To this end the amplifier of transmit side CABT/R module 20 and the rectifier of receive side CABT/R module 40 may both be reconfigurable to function as either amplifier or rectifier. These devices may collectively be referred to as “differential self-synchronous radio frequency power amplifier/rectifiers”. Given the bidirectionality of power transmission, transmitter resonator 30 and receiver resonator 50 may both be described as “transmitter-receiver resonators”.

Transmitter resonator 30 and receiver resonator 50 may be configured to capture power with the frequency set by an oscillating signal in respectively CABT/R module 20 and CABT/R module 30 such as, for example without limitation between 1 MHz and 1 GHz. A more detailed listing of oscillating signal frequencies is provided in publication WO2023/175399A2 and includes the Industrial, Scientific and Medical (ISM) frequency bands. For other applications, frequencies in officially reserved application bands may be preferred, for example without limitation, Police Communication or Military bands. Receiver resonator 50 may be configured to capture power from magnetic field 31A or electric field 31B or any combination of these two fields at that frequency.

In some embodiments, components in CABT/R modules 20 and 40 are discrete elements while in other embodiments, one or more components are part of an integrated circuit design.

In WO2023/175399A2, an extensive description is provided of different mechanisms that may be employed for communicating information about the load and/or receiver subsystem 14 of FIG. 1 back to an internal controller in transmit side CABT/R module 20. The differential self-synchronous radio frequency power amplifier/rectifier of receive side CABT/R module 40 may serve as modulator for receive side CABT/R module 40. The modulation may be Amplitude Modulation, Frequency Modulation, or Phase Modulation and the information may be modulated in analog or digital form onto the system resonant frequency, a harmonic of the resonant frequency, or a frequency that is neither of the foregoing. In some embodiments, the system resonant frequency may be a harmonic of the frequency used for information transfer. WO2023/175399A2 also lists other technologies acceptable for information transfer between CABT/R modules 40 and 20.

In view of the above, system 10 of FIG. 1 may function as a full-duplex transmit-receive system for transmitting information in both directions via resonators 30 and 50. System 10 of FIG. 1 may comprise further receiver subsystems similar to receiver subsystem 14 of FIG. 1. When additional receiver subsystems are present, the arrangement described above allows communication of information among the various receiver subsystems.

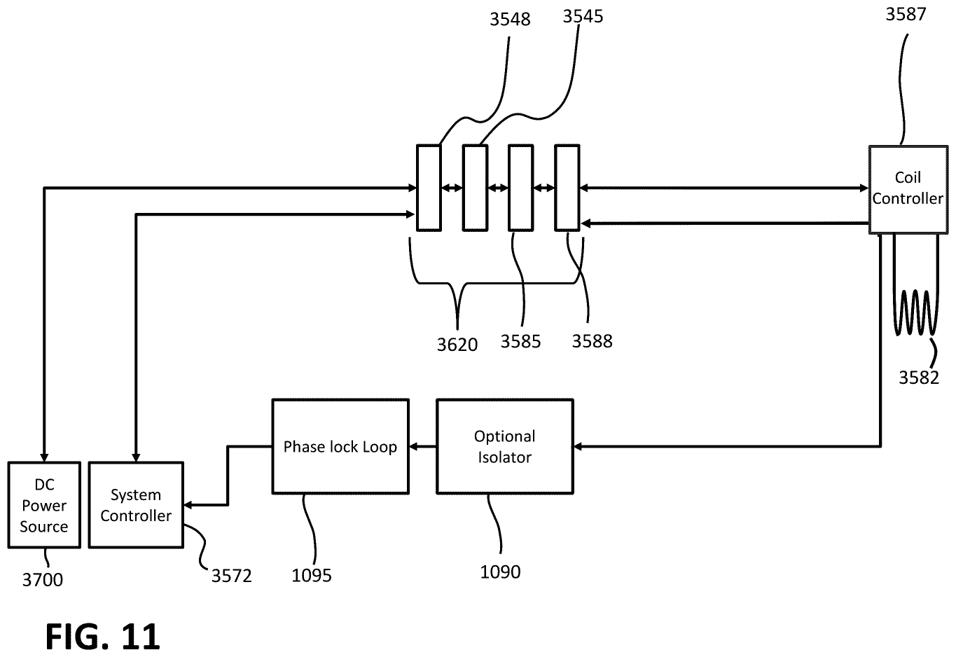

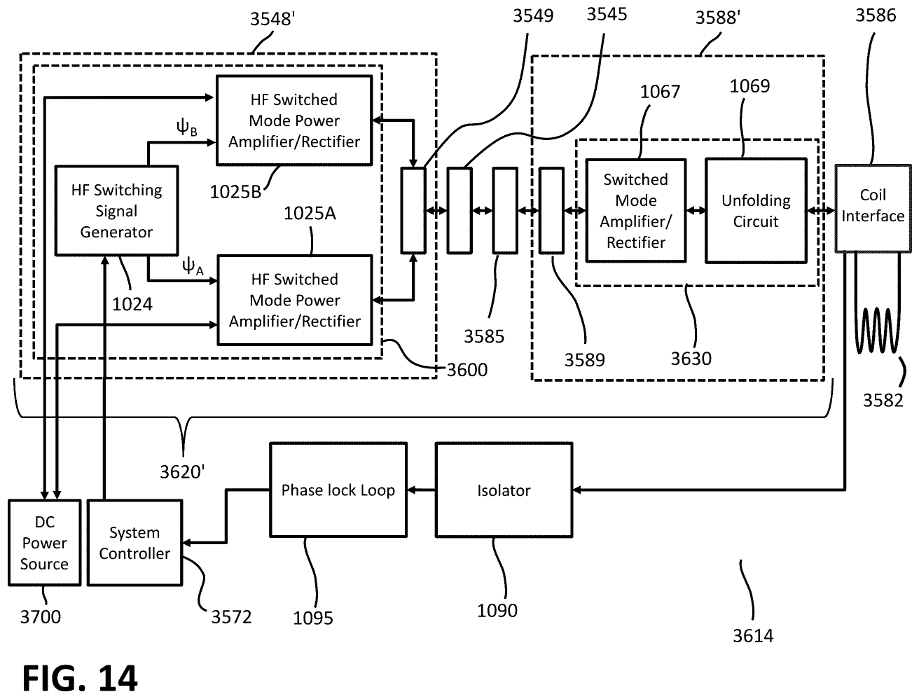

FIG. 11 shows a schematic electrical circuit of one power transfer channel of any of the systems of FIGS. 5 to 10. All the elements of FIG. 11 have already been described with reference to FIGS. 5 to 10. The schematic circuit in FIG. 11 is presented in an extended fashion aimed at facilitating comparison with the schematic circuit for a further implementation presented in FIG. 14 below. CABT/R modules 3548 and 3588, together with resonators 3545 and 3585 constitute a bimodal high frequency near-field wireless power transfer link 3620. The labelling of CABT/R modules and resonators employed in FIG. 11, is that of FIG. 5. In the system of FIG. 11, system controller 3572 and DC Power Source 3700 are employed instead of respectively the Controller and Protection Circuitry, and the Photovoltaic Cell of publication WO2023/175399A2.

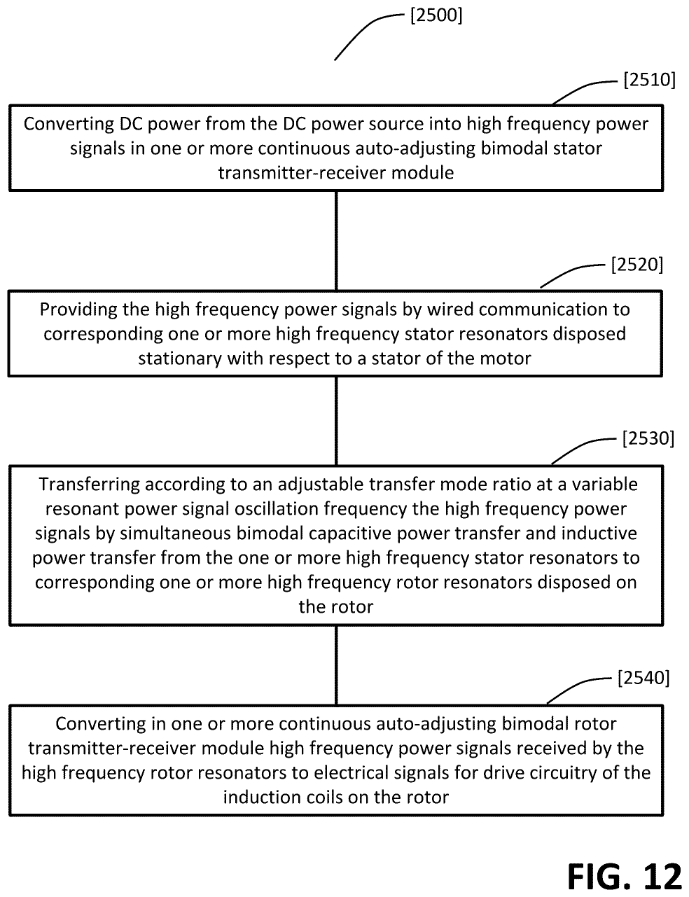

With reference to the flow chart of FIG. 12 and FIGS. 1 to 11, while using the labelling of FIG. 11, contactless method [2500] is provided for transferring electrical power from a DC power source 3700 to induction coils 3582, 3582B on rotor 3580 of electric motor-generator 3500, the method comprising: converting [2510] DC power from DC power source 3700 into high frequency power signals in one or more continuous auto-adjusting bimodal stator transmitter-receiver module 3548; providing [2520] the high frequency power signals by wired communication to corresponding one or more high frequency stator resonators 3545 disposed stationary with respect to stator 3590 of motor-generator 3500; transferring [2530] according to an adjustable transfer mode ratio at a variable resonant power signal oscillation frequency the high frequency power signals by simultaneous bimodal capacitive power transfer and inductive power transfer from the one or more high frequency stator resonators 3545 to corresponding one or more high frequency rotor resonators 3585 disposed on rotor 3580; and converting [2540] in one or more continuous auto-adjusting bimodal rotor transmitter-receiver module 3588 high frequency power signals received by the high frequency rotor resonators 3585 to electrical signals for drive circuitry of induction coils 3582 on rotor 3580.

Converting [2510] the DC power may comprise adjusting a frequency, a phase, and a duty cycle of the high frequency power signals. Transferring [2530] the high frequency signals may comprise allowing the power signal oscillation frequency to freely vary within a predetermined frequency band according to an output load experienced by the one or more continuous auto-adjusting bimodal stator transmitter-receiver module 3548. Method [2500] may further comprise controlling by means of systems controller 3572 in wired communication with the one or more continuous auto-adjusting bimodal stator transmitter-receiver module 3548 the application of DC power to individual ones of the one or more continuous auto-adjusting bimodal stator transmitter-receiver module 3548.

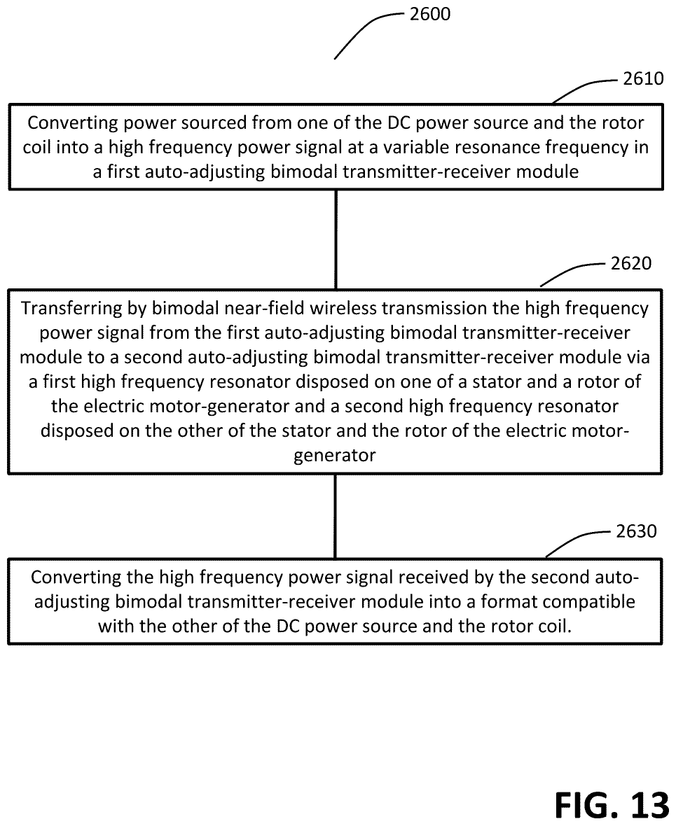

In a further aspect described with reference to the flowchart in FIG. 13, method is provided for bidirectionally transferring electrical power between DC power source 3700 and rotor coil 3582 of electric motor-generator 3500 configured for operating both as an electric motor and as an electric generator, the method comprising: converting [2610] power sourced from one of DC power source 3700 and rotor coil 3582 into a high frequency power signal at a variable resonance frequency in first auto-adjusting bimodal transmitter-receiver module 3548/3588; transferring [2620] by bimodal near-field wireless transmission the high frequency power signal from first auto-adjusting bimodal transmitter-receiver module 3548/3588 to second auto-adjusting bimodal transmitter-receiver module 3588/3548 via first high frequency resonator 3545/3585 disposed on one of stator 3590 and rotor 3580 of electric motor-generator 3500 and second high frequency resonator 3585/3545 disposed on the other of stator 3590 and rotor 3580 of electric motor-generator 3500; and converting [2630] the high frequency power signal received by second auto-adjusting bimodal transmitter-receiver module 3588/3548 into a format compatible with the other of DC power source 3700 and rotor coil 3582. The term “format” is employed herein to refer to whether the power signal provided is AC or DC.

The direction of power transfer is changed by switching a first differential self-synchronous radio frequency power amplifier/rectifier in first auto-adjusting bimodal transmitter-receiver module 3548/3588 to one of an amplifying mode and a rectifying mode and switching a second differential self-synchronous radio frequency power amplifier/rectifier in second auto-adjusting bimodal transmitter-receiver module 3588/3548 to the other of the amplifying mode and the rectifying mode.

FIG. 14 shows an embodiment of system 3614 for electrically powering rotor coils of electric motor-generator 3500 based on the systems of FIGS. 5 to 10. FIG. 11, which presents the electronic circuitry of FIGS. 5 to 10, is employed as departure point for describing the circuit of FIG. 14. The distinction between the embodiment in FIG. 14 and the embodiment in FIG. 11 is in the mechanism for powering rotor coil 3582.

In the embodiment shown in FIG. 11, industrial coil signal controller 3587 is employed to drive rotor coil 3582. By contrast, in system 3614 of FIG. 14, the frequency- and/or phase-based mechanisms already described in publication WO2023/175399A2 is employed instead of industrial coil signal controllers 3587. In system 3614, system controller 3572 and DC Power Source 3700 have both already been addressed with respect to FIG. 11. Instead of employing industrial coil signal controller 3587 of FIG. 11, the circuit of FIG. 14 employs simpler rotor coil interface 3586. Rotor coil interface 3586, at a minimum, may serve to match the impedance of unfolding circuit 1069 to that of rotor coil 3582. It may also comprise sensors for sensing operational parameters of rotor coil 3582 and means for transmitting the sensor signals. It may also comprise electronic filters for filtering electrical noise from sensor signals to be sent to system controller 3572.

System 3614 of the type shown in FIG. 14 is employed to provide power to each individual rotor coil 3582 in rotor 3580 and the nature of the power signal delivered to each rotor coil 3582 is controlled by system controller 3572. It is to be understood that single system controller 3572 controls a plurality of coils 3582, each driven by a circuit as shown in FIG. 14.

In system 3614 of FIG. 14, CABT/R 3548′ is shown in partially exploded view, showing its signal generation and amplifier/rectifier section 3600 in more detail. In the system of FIG. 11, CABT/R 3548 comprises a single oscillator and a single differential self-synchronous radio frequency power amplifier/rectifier. By contrast, in FIG. 14, signal generation and amplifier/rectifier section 3600 of CABT/R 3548′ comprises HF Switching signal generator 1024 and HF Switched Mode Power Amplifier/Rectifiers 1025A and 1025B. The phrase “switchable power signal modulator/rectifier” is used in this disclosure to describe amplifier/rectifier section 3600. The functioning of switchable power signal modulator/rectifier 3600 has been described in detail in publication WO2023/175399A2. The remainder of the circuitry of CABT/R 3548′, shown schematically as a single box 3549 in FIG. 14, may be the same as described with respect to FIG. 11 and expounded on in publication WO2023/175399A2. In the present application, this remainder portion 3549 of CABT/R 3548′ is referred to as a “Power Signal Tuning Network”, sometimes abbreviated simply to Tuning Network 3549.

In FIG. 14, receiver side CABT/R 3588′ is also shown in partially exploded view. Power signal conversion circuit 3630 of receiver side CABT/R 3588′ is shown in more detail. In comparing CABT/R 3588′ of FIG. 14 with CABT/R 3588 of FIG. 11, it is noted that the HF Switched Mode Power Amplifier/Rectifier and load management circuit of CABT/R 3588 are replaced in FIG. 14 by the combination of HF Switched Mode Power Amplifier/Rectifier 1067 and unfolding circuit 1069. In the present application, we refer to the combination of HF Switched Mode Power Amplifier/Rectifier 1067 and unfolding circuit 1069 as a Power Signal Conversion Circuit 3630. The remainder of the circuitry of CABT/R 3588′, shown schematically as a single box 3589 in FIG. 14, may be the same as described with respect to FIG. 11 and expounded on in publication WO2023/175399A2. In the present application, this remainder portion 3589 of CABT/R 3588′ is also referred to as a “Power Signal Tuning Network”, sometimes abbreviated simply to Tuning Network 3589.

Switchable power signal modulator/rectifier 3600 extracts DC power from DC Power Source 3700 by means of first and second HF Switched Mode Power Amplifier/Rectifiers 1025A and 1025B, switched by respectively first and second switching signals ψ_{A} and ψ_{B} provided by HF switching signal generator 1024 under control of system controller 3572. System 3614 mixes in stator resonator 3545 the first and second power signals of differing phase or differing frequency supplied from HF Switched Mode Power Amplifier/Rectifiers 1025A and 1025B. The mixing produces from Power Signal Tuning Network 3589 a transferred power signal that may be manipulated by HF switching signal generator 1024 via switching signals ψ_{A} and ψ_{B}.

When switchable power signal modulator/rectifier 3600 is in the modulating mode, it receives DC power from DC power source 3700 and outputs to Power Signal Tuning Network 3549 two separate power signals at either different frequencies or different phases based on switching signals ψ_{A} and ψ_{B} provided by HF Switching signal generator 1024 under control of system controller 3572. When switchable power signal modulator/rectifier 3600 is in the rectifying mode, it receives a power signal from Power Signal Tuning Network 3549 and outputs to DC power source 3700 a DC signal under control of system controller 3572. The mode-switching instructions are generated by system controller 3572.

CABT/R 3548′ and HF resonator 3545 may be implemented in or on stator 3590 or stator housing of motor-generator 3500. HF resonator 3585 and CABT/R 3588′ may be incorporated on rotor 3580 of motor-generator 3500, along with coil interfaces 3586. Besides impedance matching circuitry, coil interfaces 3586 may comprise a variety of sensors useful in controlling motor-generator 3500 as well as circuitry for communicating data to HF switching signal generator 1024. Signal generator 1024 and communications means are described in more detail later below.

The physical dispositions and arrangements of CABT/R modules 3548′, 3588′ and resonators 3545, 3585 of FIG. 14 may be the same with respect to one another as CABT/R modules 3548, 3588 and resonators 3545, 3585 of FIG. 11 with respect to one another. The conceptual electrical circuit difference between the electric motor-generator implementation of FIG. 14 and the implementation of FIGS. 5 to 10, as captured in FIG. 11, is best seen by directly comparing FIG. 14 with FIG. 11. It bears pointing out that elements 3548, 3588, 3545 and 3585 of FIG. 11 constitute bimodal high frequency near-field wireless power transfer link 3620, and, notwithstanding the different implementation of the system of FIG. 14, elements 3548′, 3588′, 3545 and 3585 of FIG. 14 also constitute a bimodal high frequency near-field wireless power transfer link 3620′.

### The Δf System

If switching signals ψ_{A} and ψ_{B} have a difference frequency of Δf, the signal produced by switched mode Amplifier/Rectifier 1067 in its rectifier mode is in the form of a train of adjoining halfwaves of the same polarity with a frequency equal to the difference frequency Δf. The rectified power signal is received by unfolding circuit 1069 and every second halfwave is inverted to form a generally sinusoidal unfolded output power signal at a frequency of Δf/2. The action of unfolding circuit 1069 may be controlled via system controller 3572 via control lines which, in order to avoid clutter, are not shown in FIG. 14. The term “unfolded output power signal” is used to describe the power signal provided to coil Interface 3586 by unfolding circuit 1069.

Bimodal high frequency near-field wireless power transfer link 3620′ prime is a tuned system. All signals received via receiving resonator 3585 and passing through tuning network 3589 may be filtered except for the carrier signal bearing the modulation at the difference frequency Δf. Switched mode Amplifier/Rectifier 1067 in its rectifier mode and unfolding circuit 1069 also further ensure the passage of only the modulation at the difference frequency Δf through system 3614 to coil interface 3586. Imposing a frequency difference Δf between switching signals ψ_{A} and ψ_{B} therefore causes system 3614 to provide an AC signal at a frequency of Δf/2 to Coil Interface 3586.

### The Δϕ System

As explained in some detail in publication WO2023/175399A2, imposing a phase difference Δϕ between switching signals ψ_{A} and ψ_{B} provides through system 3614 a DC signal to coil Interface 3586. The phase difference Δϕ may be modulated in HF switching generator 1024 of switchable power signal modulator/rectifier 3600 at a modulation frequency f_{M} to provide to the coil Interface 3586 an AC power signal at the modulation frequency f_{M}.

From the above it follows that there are at least two different mechanisms for providing managed AC power signals to rotor coils 3582 and one way of providing DC power signals to coils 3582 by the manipulation of switching signals to HF Switched Mode Power Amplifier/Rectifiers 1025A and 1025B of switchable power signal modulator/rectifier 3600. By the use of system 3614 of FIG. 14, coil signal controllers 3587 of the systems in FIG. 11 may thus be eliminated and replaced with simpler coil Interfaces 3586.

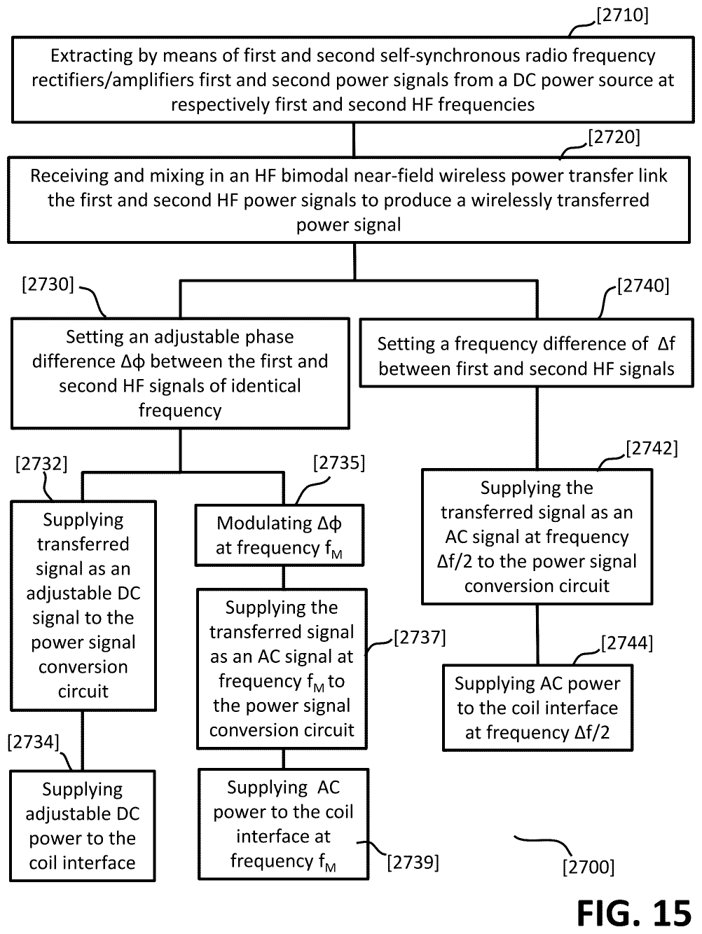

With reference to FIG. 14 and FIG. 15, method [2700] is provided for transferring power between DC power source 3700 and rotor coil 3582 of electric motor-generator 3500, the method comprising: extracting [2710] from DC power source 3700 at first and second HF frequencies corresponding first and second high frequency (HF) power signals via corresponding first and second self-synchronous radio frequency amplifier/rectifiers 1025A and 1025B; receiving [2720] and mixing in a bimodal high frequency near-field wireless power transfer link 3620′ the first and second HF power signals to produce a transferred power signal; producing in power signal conversion circuit 3630 of CABT/R module 3588 an output power signal from the transferred power signal; and supplying the output power signal to rotor coil 3582 via rotor coil interface 3586.

The method may further comprise: generating in an HF switching signal generator 1024 and communicating to the first and second amplifier/rectifiers 1025A, 1025B first and second switching signals at the respective first and second HF frequencies; and establishing and controlling in the HF switching signal generator 1024 a mutual phase relationship between the first and second switching signals.

The method may further comprise: receiving and rectifying in switched mode amplifier/rectifier 1067 of power signal conversion circuit 3630 the transferred power signal; and receiving and unfolding in unfolding circuit 1069 of power signal conversion circuit 3630 the rectified power signal from switched mode amplifier/rectifier 1067.

The method may further comprise: unfolding the rectified power signal; communicating control information to HF switching signal generator 1024 from the rest of the system via power signal conversion circuit 3630 and first and second self-synchronous radio frequency amplifier/rectifiers 1025A, 1025B; controlling the plurality of elements of the system by system controller 3572 in data communication with the plurality of elements; and communicating to HF switching signal generator 1024 information about at least one of a DC level, a frequency and a phase of a power signal in rotor coil 3582 using an isolatable load information circuit comprising phase lock loop 1095 and optional isolator system 1090.

Transferring the power signal may comprise wirelessly transferring the power signal. Wirelessly transferring the power signal may comprise bimodal wirelessly transferring the power signal.

As represented by branch [2730] of FIG. 15, there are two methods for transferring power from DC power source 3700 to rotor coil 3582 in which power transfer system 3614 employs a phase difference between switching signals. In these implementations, the first and second HF frequencies of the first and second switching signals have the same frequency; and the first and second switching signals have a mutual phase difference adjustable by HF switching signal generator 1024.

A first of two methods comprises: adjusting [2732] the mutual phase difference between first and second switching signals based on the DC level in rotor coil 3582 to produce a transferred power signal as a DC signal correspondingly adjusted [2734] in amplitude.

A second of two methods comprises: modulating [2735] the mutual phase difference between first and second switching signals at a phase modulation frequency f_{M} to produce a transferred power signal as an AC power signal modulated at phase modulation frequency f_{M} (See steps [2737] and [2739] of FIG. 15).

A method for the frequency-difference based implementation represented by branch of FIG. 15 comprises: determining first and second HF frequencies of corresponding first and second switching signals; and setting [2740] a difference frequency Δf equal to double a frequency of the power signal to be supplied to rotor coil 3582. This method further comprises: producing [2742] a transferred power signal at the difference frequency; and supplying [2744] the the transferred power signal as an output power signal to rotor coil 3582.

Returning now to FIG. 14, System Controller 3572 ensures the relationship between pairs of switching signals ψ_{A} and ψ_{B} employed in a plurality of systems 3614 to thereby ensure the correct functioning of a corresponding plurality of rotor coils 3582. The HF switching generators 1024 of all of systems 3614 may be incorporated as single central HF switching generator 1024 in System Controller 3572 and single central HF switching generator 1024 may provide different pairs of switching signals ψ_{A} and ψ_{B} to different pairs of self-synchronous radio frequency amplifier/rectifiers 1025A, 1025B of each system 3614 corresponding to each coil 3582.

In the system of FIG. 14, the frequency of the power signal(s) applied to rotor coil(s) 3582 is determined by system controller 3572, which is a specifically configured controller unavailable from prior art industrial controllers. For system controller 3572 to be able to manage the “slip” in the system and control the speed of rotor 3580, information from the sensors in coil interfaces 3586 corresponding to each coil 3582 has to find its way to system controller 3572. This may be done via phase lock loop 1095 and isolator 1090. Isolator 1090 serves to transmit the sensor signals across the electrical gap between rotating rotor 3580 and stator 3590 bearing system controller 3572.

Bimodal high frequency near-field wireless power transfer link 3620′ may transfer power in either direction. When CABT/R 3548′ is switched to send mode, CABT/R 3588′ is switched to receive mode to allow transfer of power from DC power source 3700 to coil 3582. When CABT/R 3548′ is switched to receive mode, CABT/R 3588′ is switched to send mode to allow transfer of power from coil 3582 to DC power source 3700. The mode-switching is based on the use of differential self-synchronous radio frequency power amplifier/rectifiers in CABT/R 3548′ and CABT/R 3588′.

When electric motor-generator 3500 is in generator mode, Power Signal Conversion Circuit 3630 is switched to a mode in which power signals from coil 3582 are passed via coil interface 3586 and into bimodal high frequency near-field wireless power transfer link 3620′ without any signal-affecting action by Unfolding Circuit 1069. This may be achieved, for example by connecting the input of Unfolding Circuit 1069 to its own output. In the present disclosure, the term “amplifying mode” is used to describe this state of power signal conversion circuit 3630. CABT/R 3588′ is switched to a transmitting mode and CABT/R 3548′ is switched to a receiving mode. Bimodal high frequency near-field wireless power transfer link 3620′ thereby is switched to a reverse power transfer mode in which power received via Power Signal Conversion Circuit 3630 is transferred to HF Switched Mode Power Amplifier/Rectifiers 1025A and 1025B. HF Switched Mode Power Amplifier/Rectifiers 1025A and 1025B are switched to a rectifying mode, thereby allowing power received in bimodal high frequency near-field wireless power transfer link 3620′ from coil 3582 to be transferred as DC power to DC Power source. In an embodiment in which DC Power source 3700 is a rechargeable battery, this DC Power may be used to recharge DC power source 3700. All mode switching is under the control of system controller 3572 by means of communication mechanisms already described above and in more detail in WO2023/175399A2. Bidirectional connections between elements of System 3614 in FIG. 14 indicate potential bidirectional transfer of power.

FIGS. 1 to 10, 11 and 14 describe implementations of brushless rotary electric motor-generator 3500 powerable by DC power source 3700, electric motor-generator comprising: stator 3590 comprising annularly arranged about a rotor rotation axis one of a plurality of stator magnets and a plurality of stator induction coils; system controller 3572 disposed stationary with respect to the stator 3590; rotor 3580 disposed to rotate relative to stator 3590 about rotor rotation axis 3510 and comprising one or more rotor coils 3582; and one or more corresponding bimodal high frequency near-field wireless power transfer links 3605, 3606, 3608, 3609, 3610, 3620, 3620′ configured for transferring power across an electrical gap between rotor 3580 and a rest of motor-generator 3500 by simultaneous bimodal capacitive power transfer and inductive power transfer of high frequency power signals according to an adjustable transfer mode ratio at a variable resonant power signal oscillation frequency.

In one implementation as per FIG. 11, each bimodal high frequency near-field wireless power transfer link 3620 may be under control of system controller 3572 and in wired communication with the DC power source 3700 and with the one or more rotor coils via at least one coil signal controller 3587. Each bimodal high frequency near-field wireless power transfer link 3620 may be configured for bidirectionally transferring the high frequency power signals across the electrical gap.

In one implementation as per FIG. 14, each bimodal high frequency near-field wireless power transfer link 3620′ may comprise: disposed stationary with respect to stator 3590, switchable power signal modulator/rectifier 3600 in wired communication with DC power source 3700 and with corresponding stator resonator 3545 via stator power signal tuning network 3549; and disposed on rotor 3580, power signal conversion circuit 3630 in wired communication with corresponding rotor resonator 3585 via rotor power signal tuning network 3589 and with rotor coil 3582 via coil interface 3586. Each switchable power signal modulator/rectifier 3600 may be configured to be switchable between a first modulating and a second rectifying mode; each power signal conversion circuit 3630 may be configured to be switchable between a first amplifying mode and a second rectifying and unfolding mode; and when switchable power signal modulator/rectifier 3600 is switched to one of its first and its second mode, corresponding power signal conversion circuit 3630 is switched to the other of its first and its second mode.

In the system of FIG. 14, each switchable power signal modulator/rectifier 3600, when in the modulating mode, is configured for receiving from DC power source 3700 a DC power signal and producing from the DC power signal first and second power signals having between them one of a phase difference and a frequency difference and for providing the first and second power signals to corresponding stator resonator 3545; each corresponding stator resonator 3545 is configured for mixing the first and second power signals to produce a mixed power signal and for transmitting the mixed power signal across the electrical gap to corresponding power signal conversion circuit 3630; and power signal conversion circuit 3630 in its second mode is configured for rectifying and unfolding the mixed and transmitted power signal to produce an output power signal and for transmitting the output power signal to corresponding rotor coil 3582 via the corresponding rotor coil interface 3586. System controller 3572 may be configured for controlling a rotation rate of rotor 3580 by controlling the first and second power signals based on information received by controller 3572 from rotor coil interface 3586.

In the system of FIG. 14, first and second power signals produced in each of switchable power signal modulator/rectifiers 3600 may have between them a frequency difference set by system controller 3572 in corresponding switchable power signal modulator/rectifier 3600 based on information communicated from corresponding rotor coil interface 3586; and the output power signal may be provided by power signal conversion circuit 3630 to corresponding rotor coil 3582 as an AC signal at a frequency of half of the difference frequency.

In the system of FIG. 14, first and second power signals produced in each of switchable power signal modulator/rectifiers 3600 may have between them a phase difference set by system controller 3572 in corresponding switchable power signal modulator/rectifier 3600 based on information communicated from corresponding rotor coil interface 3586; and the output power signal may be provided to corresponding rotor coil 3582 as a DC signal.

In the system of FIG. 14, first and second power signals produced in each of switchable power signal modulator/rectifiers 3600 may have between them a phase difference set by system controller 3572 in corresponding switchable power signal modulator/rectifier 3600 based on information communicated from corresponding rotor coil interface 3586; corresponding switchable power signal modulator/rectifier 3600 may be configured by system controller 3572 to modulate the phase difference at a modulation frequency; and the output signal may be provided to corresponding rotor coil 3582 as an AC power signal at the modulation frequency.

In the system of FIG. 14, each of power signal conversion circuits 3630, when in its amplifying mode, may be configured to receive from corresponding rotor coil 3582 a generated power signal and to pass the generated power signal to corresponding switchable power signal modulator/rectifier 3600; and corresponding switchable power signal modulator/rectifier 3600, when in its rectifying mode, may be configured to rectify the generated power signal to a converted DC power signal and to provide the converted DC power signal to DC power source 3700.

In all of the implementations described herein, each of the one or more bimodal high frequency near-field wireless power transfer links 3620, 3620′ comprises one high frequency stator resonator 3545 disposed stationary with respect to stator 3590 and one corresponding high frequency rotor resonator 3585 disposed on rotor 3580 for resonant coupling with high frequency stator resonator 3545 at the variable resonant power signal oscillation frequency; each of high frequency stator resonators 3545 is in wired communication with corresponding high frequency continuous auto-adjusting bimodal transmitter-receiver module 3548, 3548′, and each of high frequency rotor resonators 3585 is in wired communication with corresponding high frequency continuous auto-adjusting bimodal transmitter-receiver module 3588, 3588′ on rotor 3580; and during the rotation of rotor 3580 about rotor rotation axis 3510 one or more high frequency rotor resonators 3585 correspond one-at-a-time with each one of high frequency stator resonators 3545.

In some implementations, rotary motor-generator 3500 may comprise a single bimodal high frequency near-field wireless power transfer link 3620, 3620′ comprising single high frequency rotor resonator 3585 arranged annularly at a first radius about rotor rotation axis 3510 and single high frequency stator resonator 3545 arranged annularly at a second larger radius about rotation axis 3510.

In some implementations, rotary motor-generator 3500 may comprise, spaced along the rotor rotation axis, a plurality of bimodal high frequency near-field wireless power transfer links 3620, 3620′ each comprising single high frequency rotor resonator 3585 arranged annularly at a first radius about rotor rotation axis 3510 and single high frequency stator resonator 3545 arranged annularly at a second larger radius about rotation axis 3510.

In some implementations rotary motor-generator 3500 may comprise a plurality of bimodal high frequency near-field wireless power transfer links 3620, 3620′ wherein a plurality of high frequency rotor resonators 3585 is arranged annularly at a first radius about rotor rotation axis 3510 and a plurality of corresponding high frequency stator resonators 3545 is arranged annularly at a second larger radius about rotation axis 3510.

In some implementations, rotary motor-generator 3500 may comprise a plurality of bimodal high frequency near-field wireless power transfer links 3620, 3620′ wherein single high frequency rotor resonator 3585 is arranged annularly at a first radius about rotor rotation axis 3510 and a plurality of high frequency stator resonators 3545 is arranged annularly at a second larger radius about rotation axis 3510.

In some implementations, rotary motor-generator 3500 may comprise a plurality of bimodal high frequency near-field wireless power transfer links 3620, 3620′ wherein a first plurality of high frequency rotor resonators 3585 is arranged annularly at a first radius about rotor rotation axis 3510 and a plurality of high frequency stator resonators 3545 is arranged annularly at a second larger radius about rotation axis 3510 wherein the second plurality is larger in number than the first plurality.

In some implementations, rotary motor-generator 3500 may comprise one or more bimodal high frequency near-field wireless power transfer links 3620, 3620′ wherein the one or more high frequency rotor resonators 3585 are disposed radially symmetrically on a cap end surface of rotor shaft 3584 and each of the one or more corresponding high frequency stator resonators 3545 is disposed radially symmetrically about rotation axis 3510 proximate corresponding high frequency rotor resonator 3585.

In electric motor-generator 3500 having stator 3590 and rotor 3580 disposed to rotate relative to stator 3590 about rotor rotation axis 3510 and wherein rotor 3580 has one or more rotor coils 3582, a method is provided with reference to FIGS. 1 to 15 for transferring power between DC power source 3700 and the one or more rotor coils 3582, the method comprising transferring power near-field wirelessly and bimodally at high frequency across an electrical gap between rotor 3580 and other components of motor-generator 3500 according to an adjustable transfer mode ratio between capacitive power transfer and inductive power transfer at a variable resonant power signal oscillation frequency in one or more bimodal high frequency near-field wireless power transfer links 3620, 3620′.

To transfer power from DC power source 3700 to rotor coils 3582, the method may further comprise: placing electric motor-generator 3500 in a motor mode; converting within the one or more bimodal high frequency near-field wireless power transfer links 3620, 3620′ power sourced from DC power source 3700 into high frequency power signals at the power signal oscillation frequency; and receiving in each of the one or more corresponding rotor coils 3582 an output power signal via corresponding one or more bimodal high frequency near-field wireless power transfer links 3620, 3620′.

Each bimodal high frequency near-field wireless power transfer link 3620′ may comprise: disposed stationary with respect to stator 3590, switchable power signal modulator/rectifier 3600 in wired communication with DC power source 3700 and with corresponding stator resonator 3545; disposed on rotor 3580, power signal conversion circuit 3630 in wired communication with corresponding rotor resonator 3585 and with rotor coil 3582; and the method for transferring power may comprise: switching switchable power signal conversion circuit 3630 to a rectifying and unfolding mode; switching switchable power signal modulator/rectifier 3600 to a modulating mode; producing in switchable power signal modulator/rectifier 3600 from the power sourced from the DC power source 3700 first and second power signals having between them one of a frequency difference and a phase difference; mixing first and second power signals to produce a mixed power signal; transmitting the mixed power signal from stator resonator 3545 to rotor resonator 3585 across the electrical gap; and rectifying and unfolding the mixed power signal in power signal conversion circuit 3630 to produce the output power signal.

Three methods are presented for producing AC or DC signals to be supplied to rotor coils 3582. The first method comprises establishing between the first and second power signals a difference frequency whereby the output power signal is received in rotor coil 3582 as an AC signal at a frequency of half of the difference frequency. The second method comprises establishing between the first and second power signals a phase difference whereby the output power signal is received in rotor coil 3582 as a DC power signal. The third method comprises establishing between the first and second power signals a phase difference and modulating the phase difference at a modulation frequency, whereby the output power signal is received in rotor coil 3582 as an AC signal having the modulation frequency.

Producing first and second power signals in each of power signal modulator/rectifiers 3600 may comprise extracting power in the form of first and second power signals from DC power source 3700 in respectively first and second high frequency switched mode power amplifier/rectifiers 1025A and 1025B by using respective first and second switching signals provided by high frequency switching signal generator 1024 under control of system controller 3572.

To transfer power from rotor coils to the DC power source, the method may further comprise: placing electric motor-generator 3500 in a generator mode; converting within the one or more bimodal high frequency near-field wireless power transfer links 3620, 3620′ power sourced from the one or more corresponding rotor coils 3582 into high frequency power signals at the power signal oscillation frequency; and receiving power in DC power source 3700 via the one or more corresponding bimodal high frequency near-field wireless power transfer links 3620, 3620′.

Each bimodal high frequency near-field wireless power transfer link 3620′, as per FIG. 14, may comprise: switchable power signal modulator/rectifier 3600 in wired communication with DC power source 3700 and with stator resonator 3545; and switchable power signal conversion circuit 3630 in wired communication with rotor resonator 3585 and with rotor coil 3582; and the method for transferring power may further comprise: switching switchable power signal conversion circuits 3630 to an amplifying mode; switching switchable power signal modulator/rectifiers 3600 to a rectifying mode; and rectifying in switchable power signal modulator/rectifiers 3600 the power signal sourced from rotor coil 3582.

Each of the one or more bimodal high frequency near-field wireless power transfer links 3620, as per FIG. 11, may comprise: first high frequency continuous auto-adjusting bimodal transmitter-receiver module 3548 disposed stationary with respect to stator 3590 and comprising a first differential self-synchronous radio frequency power amplifier/rectifier; and second high frequency continuous auto-adjusting bimodal transmitter-receiver module 3588 on rotor 3580 and comprising a second differential self-synchronous radio frequency power amplifier/rectifier; wherein the method comprises switching the first differential self-synchronous radio frequency power amplifier/rectifier to a rectifying mode and switching the second differential self-synchronous radio frequency power amplifier/rectifier to an amplifying mode.

Each of the one or more bimodal high frequency near-field wireless power transfer links 3620 may comprise: first high frequency continuous auto-adjusting bimodal transmitter-receiver module 3548 disposed stationary with respect to stator 3590 and comprising a first differential self-synchronous radio frequency power amplifier/rectifier; and second high frequency continuous auto-adjusting bimodal transmitter-receiver module 3588 on rotor 3580 and comprising a second differential self-synchronous radio frequency power amplifier/rectifier; wherein the method comprises switching the first differential self-synchronous radio frequency power amplifier/rectifier to an amplifying mode and switching the second differential self-synchronous radio frequency power amplifier/rectifier to a rectifying mode.

The method may further comprise allowing the resonant power signal oscillation frequency in each bimodal high frequency near-field wireless power transfer link 3620, 3620′ to vary freely within a predetermined frequency band according to a load impedance experienced by bimodal high frequency near-field wireless power transfer link 3620, 3620′.

In a further aspect, a method is provided (see again FIG. 13) for bidirectionally transferring electrical power between DC power source 3700 and rotor coil 3582 of electric motor-generator 3500 configured for operating both as an electric motor and as an electric generator, the method comprising: converting power sourced from one of the DC power source 3700 and rotor coil 3582 into a high frequency power signal at a variable resonance frequency in first continuous auto-adjusting bimodal transmitter-receiver module (3548/3548′), (3588/3588′); transferring by bimodal near-field wireless transmission the high frequency power signal from the first continuous auto-adjusting bimodal transmitter-receiver module to second continuous auto-adjusting bimodal transmitter-receiver module (3588/3588′), (3548/3548′) via first high frequency resonator 3545, 3585 disposed on one of stator 3590 and rotor 3580 of the electric motor-generator and second high frequency resonator 3585,3545 disposed on the other of stator 3590 and rotor 3580 of electric motor-generator 3500; and converting the high frequency power signal received by the second continuous auto-adjusting bimodal transmitter-receiver module (3588/3588′), (3548/3548′) into a format compatible with the other of DC power source 3700 and rotor coil 3582. This method was discussed above with reference to the system of FIG. 11, but also applies to the system of FIG. 14.

With reference to the system of FIG. 11, the direction of power transfer may be changed by switching a first differential self-synchronous radio frequency power amplifier/rectifier in first continuous auto-adjusting bimodal transmitter-receiver module 3548, 3588 to one of an amplifying mode and a rectifying mode and switching a second differential self-synchronous radio frequency power amplifier/rectifier in second continuous auto-adjusting bimodal transmitter-receiver module 3588, 3548 to the other of the amplifying mode and the rectifying mode.

With reference to the system of FIG. 14, the direction of power transfer may be changed by switching at least one differential self-synchronous radio frequency power amplifier/rectifier in first continuous auto-adjusting bimodal transmitter-receiver module 3548, 3588 to one of an amplifying mode and a rectifying mode and switching at least one differential self-synchronous radio frequency power amplifier/rectifier in second continuous auto-adjusting bimodal transmitter-receiver module 3588/3548 to the other of the amplifying mode and the rectifying mode.

The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment. As used in this disclosure, except where the context requires otherwise, the term “comprise” and variations of the term, such as “comprising”, “comprises” and “comprised” are not intended to exclude other additives, components, integers or steps.

Also, it is noted that the embodiments are disclosed as a process that is depicted as a flowchart, a flow diagram, a structure diagram, or a block diagram. Although a flowchart may disclose various steps of the operations as a sequential process, many of the operations can be performed in parallel or concurrently. The steps shown are not intended to be limiting nor are they intended to indicate that each step depicted is essential to the method, but instead are exemplary steps only. In the foregoing specification, the invention has been described with reference to specific embodiments thereof. It will, however, be evident that various modifications and changes may be made thereto without departing from the broader spirit and scope of the invention. The specification and drawing are, accordingly, to be regarded in an illustrative rather than a restrictive sense. It should be appreciated that the present invention should not be construed as limited by such embodiments.

From the foregoing description it will be apparent that the present invention has a number of advantages, some of which have been described herein, and others of which are inherent in the embodiments of the invention described or claimed herein. Also, it will be understood that modifications can be made to the device, apparatus and method described herein without departing from the teachings of subject matter described herein. As such, this application is intended to cover such departures from the present disclosure as come within known or customary practice in the art to which this invention pertains the invention is not to be limited to the described embodiments except as required by the appended claims.

1. A brushless rotary electric motor-generator powerable by a DC power source, the electric motor-generator comprising:
a stator;
a system controller disposed stationary with respect to the stator;
a rotor disposed to rotate relative to the stator about a rotor rotation axis and comprising one or more rotor coils; and
one or more corresponding bimodal high frequency near-field wireless power transfer links configured for transferring power across an electrical gap between the rotor and a rest of the motor-generator by simultaneous bimodal capacitive power transfer and inductive power transfer of high frequency power signals according to an adjustable transfer mode ratio at a variable resonant power signal oscillation frequency.

2. The brushless rotary electric motor-generator of claim 1, wherein the stator is annularly arranged about the rotor rotation axis, and the stator comprises one of a plurality of stator magnets and a plurality of stator induction coils.

3. The rotary motor-generator of claim 1, wherein each bimodal high frequency near-field wireless power transfer link is under control of the system controller and in wired communication with the DC power source and with the one or more rotor coils via at least one coil signal controller.

4. The rotary motor-generator of claim 3, wherein each of the bimodal high frequency near-field wireless power transfer links is configured for bidirectionally transferring the high frequency power signals across the electrical gap.

5. The rotary motor-generator of claim 1, wherein each bimodal high frequency near-field wireless power transfer link comprises:
disposed stationary with respect to the stator a switchable power signal modulator/rectifier in wired communication with the DC power source and with a corresponding stator resonator via a stator power signal tuning network; and
disposed on the rotor a power signal conversion circuit in wired communication with a corresponding rotor resonator via a rotor power signal tuning network and with a rotor coil via a coil interface.

6. The rotary motor-generator of claim 5, wherein,
each switchable power signal modulator/rectifier is configured to be switchable between a first modulating and a second rectifying mode;
each power signal conversion circuit is configured to be switchable between a first amplifying mode and a second rectifying and unfolding mode; and
when a switchable power signal modulator/rectifier is switched to one of its first and its second mode, the corresponding power signal conversion circuit is switched to the other of its first and its second mode.

7. The rotary motor-generator of claim 6, wherein
each switchable power signal modulator/rectifier, when in the modulating mode, is configured for receiving from the DC power source a DC power signal and producing from the DC power signal first and second power signals having between them one of a phase difference and a frequency difference and for providing the first and second power signals to the corresponding stator resonator;
each corresponding stator resonator is configured for mixing the first and second power signals to produce a mixed power signal and for transmitting the mixed power signal across the electrical gap to the corresponding power signal conversion circuit; and
the power signal conversion circuit in its second mode is configured for rectifying and unfolding the mixed and transmitted power signal to produce an output power signal and for transmitting the output power signal to the corresponding rotor coil via the corresponding rotor coil interface.

8. The rotary motor-generator of claim 7, wherein the system controller is configured for controlling a rotation rate of the rotor by controlling the first and second power signals based on information received by the controller from the rotor coil interfaces.

9. The rotary motor-generator of claim 8 wherein:
the first and second power signals produced in each switchable power signal modulator/rectifier have between them a frequency difference set by the system controller in the corresponding switchable power signal modulator/rectifier based on information communicated from the corresponding rotor coil interface; and
the output power signal is provided by the power signal conversion circuit to the corresponding rotor coil as an AC signal at a frequency of half of the difference frequency.

10. The rotary motor-generator of claim 9, wherein:
the first and second power signals produced in each of the switchable power signal modulator/rectifiers have between them a phase difference set by the system controller in each switchable power signal modulator/rectifier based on information communicated from the corresponding rotor coil interface; and
the output signal is provided to the corresponding rotor coil as a DC signal.

11. The rotary motor-generator of claim 7, wherein:
the first and second power signals produced in each of the switchable power signal modulator/rectifiers have between them a phase difference set by the system controller in each switchable power signal modulator/rectifier based on information communicated from the corresponding rotor coil interface;
each switchable power signal modulator/rectifier is configured by the system controller to modulate the phase difference at a modulation frequency; and
the output power signal is provided to the corresponding rotor coil as an AC power signal at the modulation frequency.

12. The rotary motor-generator of claim 7, wherein
each of the power signal conversion circuits, when in its amplifying mode, is configured to receive from the corresponding rotor coil a generated power signal and to pass the generated power signal to the corresponding switchable power signal modulator/rectifier; and
the corresponding switchable power signal modulator/rectifier, when in its rectifying mode, is configured to rectify the generated power signal to a converted DC power signal and to provide the converted DC power signal to the DC power source.

13. The rotary motor-generator of claim 1, wherein
each of the one or more bimodal high frequency near-field wireless power transfer links comprises one high frequency stator resonator disposed stationary with respect to the stator and one corresponding high frequency rotor resonator disposed on the rotor for resonant coupling with the high frequency stator resonator at the variable resonant power signal oscillation frequency;
each of the high frequency stator resonators is in wired communication with a corresponding high frequency continuous auto-adjusting bimodal transmitter-receiver module, and each of the high frequency rotor resonators is in wired communication with a corresponding high frequency continuous auto-adjusting bimodal transmitter-receiver module on the rotor; and
during the rotation of the rotor about the rotor rotation axis, one or more high frequency rotor resonators correspond one-at-a-time with each one of the high frequency stator resonators.

14. The rotary motor-generator of claim 13, comprising a single bimodal high frequency near-field wireless power transfer link comprising a single high frequency rotor resonator arranged annularly at a first radius about the rotor rotation axis and a single high frequency stator resonator arranged annularly at a second larger radius about the rotation axis.

15. The rotary motor-generator of claim 13, comprising spaced along the rotor rotation axis a plurality of bimodal high frequency near-field wireless power transfer links each comprising a single high frequency rotor resonator arranged annularly at a first radius about the rotor rotation axis and a single high frequency stator resonator arranged annularly at a second larger radius about the rotation axis.

16. The rotary motor-generator of claim 13, comprising a plurality of bimodal high frequency near-field wireless power transfer links wherein a plurality of high frequency rotor resonators is arranged annularly at a first radius about the rotor rotation axis and a plurality of corresponding high frequency stator resonators is arranged annularly at a second larger radius about the rotation axis.

17. The rotary motor-generator of claim 13, comprising a plurality of bimodal high frequency near-field wireless power transfer links wherein a single high frequency rotor resonator is arranged annularly at a first radius about the rotor rotation axis and a plurality of high frequency stator resonators is arranged annularly at a second larger radius about the rotation axis.

18. The rotary motor-generator of claim 13, comprising a plurality of bimodal high frequency near-field wireless power transfer links wherein a first plurality of high frequency rotor resonators is arranged annularly at a first radius about the rotor rotation axis and a plurality of high frequency stator resonators is arranged annularly at a second larger radius about the rotation axis wherein the second plurality is larger in number than the first plurality.

19. The rotary motor-generator of claim 13, comprising one or more bimodal high frequency near-field wireless power transfer links wherein the one or more high frequency rotor resonators are disposed radially symmetrically on a cap end surface of a rotor shaft and each of the one or more corresponding high frequency stator resonators is disposed radially symmetrically about the rotation axis proximate the corresponding high frequency rotor resonator.

20. In an electric motor-generator having a stator and a rotor disposed to rotate relative to the stator about a rotor rotation axis and wherein the rotor has one or more rotor coils, a method for transferring power between a DC power source and the one or more rotor coils, the method comprising transferring power near-field wirelessly and bimodally at high frequency across an electrical gap between the rotor and a rest of the motor-generator according to an adjustable transfer mode ratio between capacitive power transfer and inductive power transfer at a variable resonant power signal oscillation frequency in one or more bimodal high frequency near-field wireless power transfer links.

21. The method of claim 20, comprising:
placing the electric motor-generator in a motor mode;
converting within the one or more bimodal high frequency near-field wireless power transfer links power sourced from the DC power source into high frequency power signals at the power signal oscillation frequency; and
receiving in each of the one or more corresponding rotor coils an output power signal via the corresponding one or more bimodal high frequency near-field wireless power transfer links.

22. The method of claim 21, wherein each bimodal high frequency near-field wireless power transfer link comprises:
disposed stationary with respect to the stator a switchable power signal modulator/rectifier in wired communication with the DC power source and with a corresponding stator resonator;
disposed on the rotor a power signal conversion circuit in wired communication with a corresponding rotor resonator and with a rotor coil; and
wherein the method for transferring power comprises:
switching the switchable power signal conversion circuit to a rectifying and unfolding mode;
switching the switchable power signal modulator/rectifier to a modulating mode;
producing in the switchable power signal modulator/rectifier from the power sourced from the DC power source first and second power signals having between them one of a frequency difference and a phase difference;
mixing the first and second power signals to produce a mixed power signal;
transmitting the mixed power signal from the stator resonator to the rotor resonator across the electrical gap; and
rectifying and unfolding the mixed power signal in the power signal conversion circuit to produce the output power signal.

23. The method of claim 22, further comprising establishing between the first and second power signals a difference frequency whereby the output power signal is received in the rotor coil as an AC signal at a frequency of half of the difference frequency.

24. The method of claim 22, further comprising establishing between the first and second power signals a phase difference whereby the output power signal is received in the rotor coil as a DC power signal.

25. The method of claim 22, further comprising:
establishing between the first and second power signals a phase difference; and
modulating the phase difference at a modulation frequency, whereby the output power signal is received in the rotor coil as an AC signal having the modulation frequency.

26. The method of claim 22, wherein producing the first and second power signals in each of the power signal modulator/rectifiers comprises extracting power in the form of the first and second power signals from the DC power source in respectively first and second high frequency switched mode power amplifier/rectifiers by means of respective first and second switching signals provided by a high frequency switching signal generator under control of a system controller.

27. The method of claim 20, comprising:
placing the electric motor-generator in a generator mode;
converting within the one or more bimodal high frequency near-field wireless power transfer links power sourced from the one or more corresponding rotor coils into high frequency power signals at the power signal oscillation frequency; and
receiving power in the DC power source via the one or more corresponding bimodal high frequency near-field wireless power transfer links.

28. The method of claim 27, wherein each bimodal high frequency near-field wireless power transfer link comprises:
a switchable power signal modulator/rectifier in wired communication with the DC power source and with a stator resonator; and
a switchable power signal conversion circuit in wired communication with a rotor resonator and with a rotor coil; and
wherein the method for transferring power further comprises:
switching the switchable power signal conversion circuits to an amplifying mode;
switching the switchable power signal modulator/rectifiers to a rectifying mode;
rectifying in the switchable power signal modulator/rectifiers the power signals sourced from the rotor coil.

29. The method of claim 20, wherein each of the one or more bimodal high frequency near-field wireless power transfer links comprises:
a first high frequency continuous auto-adjusting bimodal transmitter-receiver module disposed stationary with respect to the stator and comprising a first differential self-synchronous radio frequency power amplifier/rectifier; and
a second high frequency continuous auto-adjusting bimodal transmitter-receiver module on the rotor and comprising a second differential self-synchronous radio frequency power amplifier/rectifier;
wherein the method comprises switching the first differential self-synchronous radio frequency power amplifier/rectifier to a rectifying mode and switching the second differential self-synchronous radio frequency power amplifier/rectifier to an amplifying mode.

30. The method of claim 20, wherein each of the one or more bimodal high frequency near-field wireless power transfer links comprises:
a first high frequency continuous auto-adjusting bimodal transmitter-receiver module disposed stationary with respect to the stator and comprising a first differential self-synchronous radio frequency power amplifier/rectifier; and
a second high frequency continuous auto-adjusting bimodal transmitter-receiver module on the rotor and comprising a second differential self-synchronous radio frequency power amplifier/rectifier;
wherein the method comprises switching the first differential self-synchronous radio frequency power amplifier/rectifier to an amplifying mode and switching the second differential self-synchronous radio frequency power amplifier/rectifier to a rectifying mode.

31. The method of claim 20, further comprising allowing the resonant power signal oscillation frequency in each bimodal high frequency near-field wireless power transfer link to vary freely within a predetermined frequency band according to a load impedance experienced by the bimodal high frequency near-field wireless power transfer link.

32. A method for bidirectionally transferring electrical power between a DC power source and a rotor coil of an electric motor-generator configured for operating both as an electric motor and as an electric generator, the method comprising:
converting power sourced from one of the DC power source and the rotor coil into a high frequency power signal at a variable resonance frequency in a first continuous auto-adjusting bimodal transmitter-receiver module;
transferring by bimodal near-field wireless transmission the high frequency power signal from the first continuous auto-adjusting bimodal transmitter-receiver module to a second continuous auto-adjusting bimodal transmitter-receiver module via a first high frequency resonator disposed on one of a stator and a rotor of the electric motor-generator and a second high frequency resonator disposed on the other of the stator and the rotor of the electric motor-generator; and
converting the high frequency power signal received by the second continuous auto-adjusting bimodal transmitter-receiver module into a format compatible with the other of the DC power source and the rotor coil.

33. The method of claim 32, wherein a direction of power transfer is changed by switching a first differential self-synchronous radio frequency power amplifier/rectifier in the first continuous auto-adjusting bimodal transmitter-receiver module to one of an amplifying mode and a rectifying mode and switching a second differential self-synchronous radio frequency power amplifier/rectifier in the second continuous auto-adjusting bimodal transmitter-receiver module to the other of the amplifying mode and the rectifying mode.

34. The method of claim 32, wherein a direction of power transfer is changed by switching at least one differential self-synchronous radio frequency power amplifier/rectifier in the first continuous auto-adjusting bimodal transmitter-receiver module to one of an amplifying mode and a rectifying mode and switching at least one differential self-synchronous radio frequency power amplifier/rectifier in the second continuous auto-adjusting bimodal transmitter-receiver module to the other of the amplifying mode and the rectifying mode.
